(19) United States
(12) Patent Application Publication
(10) Pub. No.: US 2018/0032911 A1
(43) Pub. Date: Feb. 1, 2018

(54) PARALLEL INFORMATION PROCESSING APPARATUS, INFORMATION PROCESSING METHOD AND NON-TRANSITORY RECORDING MEDIUM

(71) Applicant: FUJITSU LIMITED, Kawasaki-shi (JP)

(72) Inventors: Masafumi Yamazaki, Tachikawa (JP); Tsuguchika TABARU, Machida (JP); Akihiko Kasagi, Kawasaki (JP)

(73) Assignee: FUJITSU LIMITED, Kawasaki-shi (JP)

(21) Appl. No.: 15/633,861

(22) Filed: Jun. 27, 2017

(30) Foreign Application Priority Data
Jul. 26, 2016 (JP) 2016-146731

(51) Int. Cl. G06N 99/00; G06F 9/54

(52) U.S. Cl. CPC G06N 99/005; G06F 9/544

(57) ABSTRACT

The parallel information processing apparatus includes a plurality of nodes each including a first processor and a second processor. The first processor is configured to execute a computation process using a coefficient for a target data, computing a coefficient variation based on a result of the computation process, transferring the computed coefficient variation to the second processor and requesting the second processor to execute a transfer/receipt process. The second processor is configured to transmit the coefficient variation transferred from the first processor to another node and receive the coefficient variation computed by another node and integrate the coefficient variation transferred from the first processor and the coefficient variation computed by another node. At least one of the first processor and the second processor updates the coefficient to be used for the computation process from next time onward based on the integrated coefficient variation.

### CROSS-REFERENCE TO RELATED APPLICATIONS

This application is based upon and claims the benefit of priority of the prior Japanese Patent Application No. JP2016-146731, filed on Jul. 26, 2016, the entire contents of which are incorporated herein by reference.

### FIELD

The disclosure relates generally to a parallel information processing apparatus, an information processing method and a non-transitory recording medium storing a program.

### BACKGROUND

Studies of Deep Learning have been actively conducted over the recent years. Exemplified are study fields of recognizing and comprehending contents of images, voices, sentences and other equivalent elements. Voice recognition during communications by mobile phones, searches on a network, detection of abnormality from a large amount of log information and further self-driving are exemplified as concrete applications of these study fields. Actual movements of projects for these applications are underway, and it is considered that applications to much broader fields will advance from now into the future.

Exemplified, incidentally, are techniques of iteratively learning big data as learning processes in a system adopting the Deep Learning. A large quantity of computation is therefore expended for these learning processes. For example, over a million of static labeled images for learning are iteratively leaned in a field of identifying the images. Hence, there is utilized a system using computation components (which will hereinafter be termed computing components) instanced by Graphics Processing Units (GPUs) capable of fast computing of operations which are in a heavy usage of the learning processes instanced by product-sum operations, or a cluster environment configured by combining a plurality of nodes including the computing components. In other words, the utilization of the computing component instanced by the GPU is effective in the learning process, and the processing can be accelerated by a scheme that the processes are shared among the plurality of computing components and thus executed by these computing components. An intra-node parallel architecture and an inter-node parallel architecture are considered as methods of sharing the processes among the plurality of computing components and thus executing the processes by the computing components.

### DOCUMENTS OF PRIOR ARTS

### Patent Documents

### [Patent Document 1] Japanese Patent Application Laid-Open Publication No. 2010-020445

### [Patent Document 2] Japanese Patent Application Laid-Open Publication No. 2012-022558

### [Patent Document 3] Japanese Patent Application Laid-Open Publication No. 2005-182785

### SUMMARY

An aspect of an embodiment is illustrated by a parallel information processing apparatus. The parallel information processing apparatus includes a plurality of nodes each including a first processor and a second processor. The first processor of each node is configured to execute a computation process using a coefficient for a processing target data, computing a coefficient variation based on a result of the computation process, transferring the computed coefficient variation to the second processor and requesting the second processor to execute a transfer/receipt process of transferring the coefficient variation to another node of the parallel information processing apparatus and receiving a coefficient variation computed by another node from another node. The second processor of each node is configured to execute a communication process of transmitting the coefficient variation transferred from the first processor to another node and receiving the coefficient variation computed by another node and an aggregation process of integrating the coefficient variation transferred from the first processor and the coefficient variation computed by another node. At least one of the first processor and the second processor updates the coefficient to be used for the computation process from next time onward based on the integrated coefficient variation.

The object and advantage of the embodiment will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a diagram illustrating processes of a neural network;

FIG. 2 is a diagram illustrating forward propagation processes and backward propagation processes;

FIG. 3 is a diagram illustrating a configuration of a parallel information processing apparatus;

FIG. 4 is a flowchart illustrating processes according to a comparative example.

FIG. 5 is a time chart illustrating the processes according to the comparative example;

FIG. 6 is a time chart illustrating processes according to an embodiment 1;

FIG. 7 is a flowchart illustrating processes of a computing node according to the embodiment 1;

FIG. 8 is a diagram illustrating a data flow in the computing node according to the embodiment 1;

FIG. 9 is a flowchart illustrating processes of the computing node according to an embodiment 2;

FIG. 10 is a diagram illustrating a data flow in the computing node according to the embodiment 2;

FIG. 11 is a time chart illustrating processes according to an embodiment 3;

FIG. 12 is a flowchart illustrating processes of the computing node according to an embodiment 3;

FIG. 13 is a flowchart illustrating details of a process of starting up a segmented weight reflection process;

FIG. 14 is a diagram illustrating queue information;

FIG. 15 is a time chart illustrating processes according to an embodiment 4;

FIG. 16 is a time chart of a processing example of prioritizing layers 1, 2 over a layer 3 in memory transfer after a learning process;

FIG. 17 is a flowchart illustrating the learning process according to the embodiment 4;

FIG. 18 is a flowchart illustrating how the process is started up according to the embodiment 4;

FIG. 19 is a diagram illustrating a time chart of the processes according to the embodiment 5 in comparison with the embodiment 4;

FIG. 20 is a flowchart illustrating an aggregation process of aggregating results of the learning processes according to the embodiment 5;

FIG. 21 is a diagram illustrating a time chart according to an embodiment 6 in comparison with the embodiment 4;

FIG. 22 is a flowchart illustrating the aggregation process and the reflection process according to the embodiment 6.

### DESCRIPTION OF EMBODIMENT(S)

With respect to Deep Learning on a system combining a plurality of nodes, processing of the Deep Learning has been accelerated so far based on intra-node parallel architecture by implementing a plurality of computing components instanced by GPUs within each of the plurality of nodes and executing the processing in parallel within each of the plurality of nodes. On the other hand, there have been less of achievements by inter-node parallel architecture configured by combining the plurality of nodes each implementing the computing components and executing the processing in parallel by the plurality of nodes.

It can be assumed as a reason for having less of achievements by the inter-node parallel architecture so far that a considerable length of time is taken for an inter-node aggregation process of coefficient information used for computing coefficients of the Deep Learning and for a process of reflecting an aggregated result in the Deep Learning as a number of the nodes increases for the Deep Learning conducted across the nodes. In other words, it can be understood that an improvement in terms of computing performance owing to an increase in number of the nodes does not sufficiently contribute to a rise in execution speed.

The Deep Learning involves iteratively executing the computation process using the coefficient for processing target data and the process of reflecting the result of the computation process in the coefficient. Under such circumstances, according to one aspect, an embodiment aims at reducing time of an inter-node process of coefficient information used for computing a coefficient when executing coefficient computation in parallel by combining nodes each implementing computing components.

The parallel information processing apparatus enables a reduction of the time of the inter-node process of the coefficient information used for computing the coefficient when executing the coefficient computation in parallel by combining the nodes each implementing the computing components.

A parallel information processing apparatus according to one embodiment will hereinafter be described with reference to the drawings.

### <Processing Example of Deep Learning>

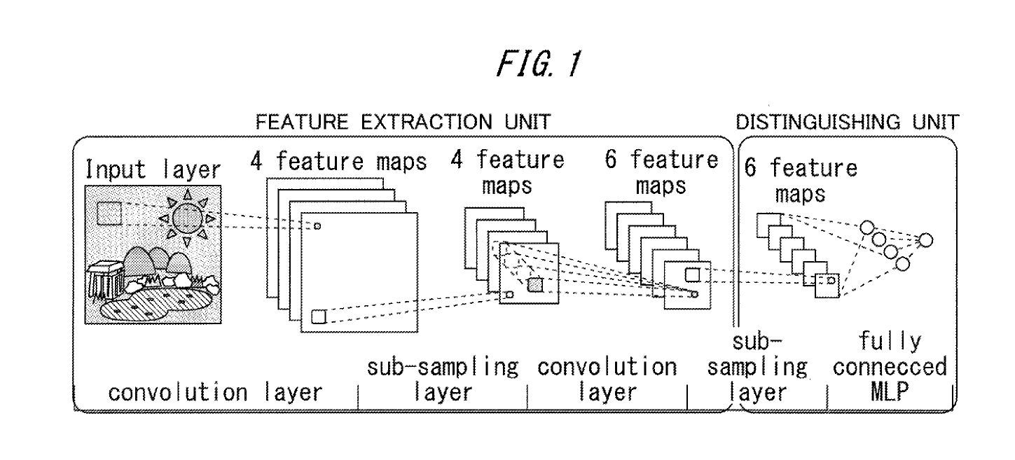

FIG. 1 illustrates processes of a neural network. The neural network executes processes in a forward direction (which is also referred to as forward propagation) for recognizing images and identifying the images, and processes in a backward direction (which is also referred to as backward propagation) for determining parameters used for the processes in the forward direction.

The neural network in FIG. 1 extracts features of the images and identifies the images by executing processes of convolution layers that perform convolution computations with respect to input images, and processes of subsampling layers (which is also referred to as pooling layers) with respect to the input images. In short, FIG. 1 illustrates the forward processes.

The forward processes include a process of a feature extraction unit to iteratively execute the processes of the convolution layers and the processes of the subsampling layers with respect to the input images, and a process of an identifying unit to output an identified result. The feature extraction unit iteratively executes the processes of the convolution layers and the processes of the subsampling layers with respect to the input images, thereby extracting thinned-out images. The process by the convolution layer is referred to also as convolution computation. A convolution computation algorithm generates image information of a next layer (an N-th layer) by executing the convolution computations using, e.g., weighting filters of an (m×m) number of weights W_{ab} (a, b=0, . . . , m−1) for information of the images having an (N×N) number of pixels. The process by the subsampling layer is defined as an image thinning-out process and is also termed a pooling computation.

Input images and output images of the computations by the convolution layers and the subsampling layers are called also feature maps. In the example of FIG. 1, a plurality of feature maps is generated by one neuron layer, corresponding to, e.g., a number of image channels or corresponding to colors instanced by RGB (Red, Green, Blue).

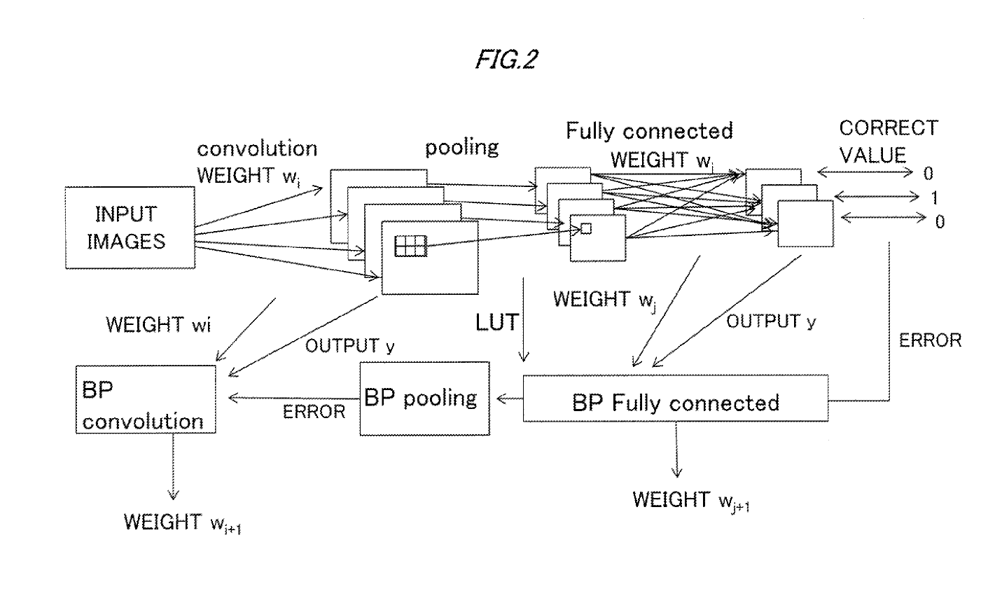

FIG. 2 illustrates backward propagation processes together with a forward propagation recognition process and a forward propagation identifying process. According to the embodiment, the forward propagation process and the backward propagation process are combined to be called a learning process. Also in the neural network of FIG. 2, the forward propagation recognition process is executed by the convolution layer performing the convolution computation and by the subsampling layer (which is written as pooling in FIG. 2) executing the subsampling process with respect to the input images. The identifying process of outputting an identified result is executed by a fully connected layer (which is written as fully connected in FIG. 2). The forward propagation convolution layer and the forward propagation subsampling layer are said to be one neuron layer. The forward propagation fully connected layer can be also said to be one neuron layer.

A result of the forward propagation process is compared with a correct value, and a difference value given as a compared result is outputted as an error. The error is processed by each backward propagation neuron layer. The backward propagation process is a process of computing an error evaluation function (ERROR) at each neuron layer and a next weight at each neuron layer sequentially in the backward propagation from the error at the fully connected layer. FIG. 2 illustrates, as current weights, one weight wᵢ at the convolution layer (1 layer) and one weight wⱼ at the fully connected layer (1 layer). Illustrated also as next weights are one weight wᵢ₊₁ at the convolution layer (1 layer) and one wⱼ₊₁ at the fully connected layer (1 layer).

In the neural network learning process using a gradient descent method, a product of a gradient of the error evaluation function (ERROR) and a learning coefficient eta (η) becomes a variation (e.g., a difference value between the current weight of the weight wt and a next weight wt+1) of the weight w. In other words, the deep learning involves executing the processes by the respective forward propagation neuron layers, and propagating the error evaluation functions (ERROR) of the respective neuron layers in the backward propagation. Each neuron layer obtains a gradient of the error evaluation function (ERROR) from the error evaluation function (ERROR) propagating backward. Each neuron layer computes the variation (which is also said to be gradient information) of the weight wt from the product of the gradient of the error evaluation function (ERROR) in such a direction as to decrease the error evaluation function (ERROR) and the learning coefficient eta (η), and thus obtains the next weight wt+1. Herein, the current weight is expressed by wt, while the weight to be used for the next computation is expressed by w+1. As described in FIG. 1, the weight w is a coefficient string (vector) having a component equal to or larger than “1” in the learning process.

Thus obtained is the variation for changing the weight in such a direction as to decrease the error evaluation function (ERROR) at the respective neuron layers sequentially in the backward propagation. The error evaluation function (ERROR) and the variation of the weight w, which are sequentially propagated backward, are computed, and finally the variation of the weight w of the layer closest to the input layer is computed. The variation of the weight wt is reflected in the weight wt+1 of the next time and is used for the learning process of the next process at each layer. Note that the following discussion will describe how time of the learning process is reduced in a parallel information processing apparatus, and details of an algorithm of the learning process itself is, however, omitted.

### <Configuration>

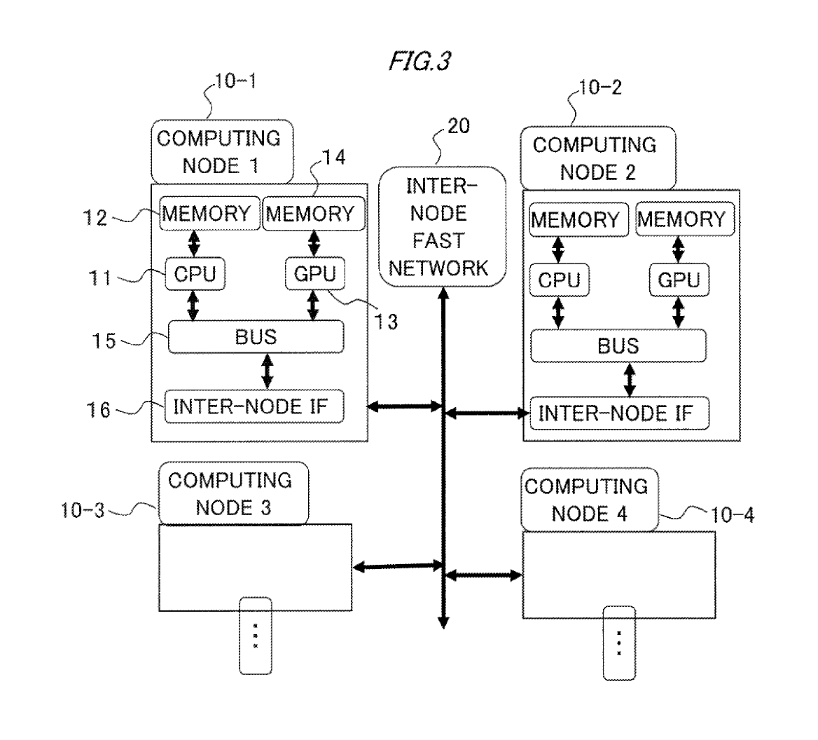

FIG. 3 illustrates a diagram of a configuration of a parallel information processing apparatus 1. The parallel information processing apparatus 1 includes computing nodes 10-1, 10-2, 10-3, 10-4 and other equivalent nodes. The computing nodes 10-1, 10-2, 10-3, 10-4 and other equivalent nodes are interconnected via inter-node fast networks 20. The computing nodes 10-1 and other equivalent nodes will be, when generically termed, simply referred to as the computing nodes 10. It does not mean that the embodiment is limited to a number of the computing nodes 10. The parallel information processing apparatus 1 executes an information processing method according to the embodiment.

Each computing node 10 includes a Central Processing Unit (CPU) 11, a memory 12 and a Graphics Processing Unit (GPU) 13, and a memory 14. The CPU 11 and the GPU 13 are interconnected via a bus 15. The CPU 11 and the GPU 13 are further connected to an inter-node interface (inter-node IF) 16 via the bus 15. The computing node 10 is one example of a “node”.

The CPU 11 executes, based on a computer program deployed in an executable manner on the memory 12, the process of the computing node 10, e.g., a communication process with other computing nodes 10, or a process of controlling and managing the GPU 13. The CPU 11 is also called a Microprocessor (MPU) or a processor. It does not mean that the CPU 11 is limited to a single processor, and a multiprocessor configuration may also be taken. The single CPU 11 connected by a single socket may have a multicore configuration. At least part of the processes of the CPU 11 may also be executed by a processor, e.g., the GPU 13, other than the CPU 11. The CPU 11 is one example of a “second processor” and simply may be called as “processing unit” in the embodiment 1. The memory 12 stores the computer program to be run by the CPU 11, and data to be processed by the CPU 11.

The GPU 13 is mounted with a plurality of fast Video Random Access Memories (VRAMs) and a plurality of fast arithmetic units, thereby executing a product-sum operation function and other equivalent functions at a high speed. The GPU 13 executes, based on the computer program deployed in the executable manner on the memory 14, e.g., the learning process of the processes of the computing node 10. The GPU 13 is one example of a “first processor” and simply may be called as “arithmetic unit” in the embodiment 1. The memory 14 stores the computer program to be run by the GPU 13 and data to be processed by the GPU 13.

At least part of the processes of the CPU 11 and the GPU 13 may be executed by a dedicated processor instanced by a Digital Signal Processor (DSP), a numeric data processor, a vector processor and an image processing processor. At least part of the processes of the respective units may also be executed by an integrated circuit (IC) and other digital circuits. At least part of the respective units may include analog circuits. The integrated circuit includes a Large Scale Integration (LSI), an Application Specific Integrated Circuit (ASIC), and a Programmable Logic Device (PLD). The PLD includes, e.g., a Field-Programmable Gate Array (FPGA).

In other words, at least part of the processes of the CPU 11 or the GPU 13 may be attained by a combination of the processor and the integrated circuit. The combination is called, e.g., a micro controller unit (MCU), a System-on-a-Chip (SoC), a system LSI and a chipset.

A BUS 15 is connected to, e.g., internal buses of the CPU 11 and the GPU 13, thereby interconnecting the CPU 11 and the GPU 13. The BUS 15 connects the CPU 11 and the GPU 13 to the inter-node IF 16. The BUS 15 is a bus conforming to, e.g., standards of PCI-Express.

The inter-node IF 16 is an interface for interconnecting the computing nodes 10 via the inter-node fast network 20. The inter-node fast network 20 is called, e.g., a crossbar, an interconnect and other equivalent nomenclatures. Note that the inter-node fast network 20 may take any type of network architecture. For example, the inter-node fast network 20 may take a mesh torus topology, and may also take a bus network topology as in the case of a Local Area Network (LAN).

### <Learning Processes by Plural Nodes>

The learning process involves at first executing the forward propagation processes at the respective neuron layers on a batch-by-batch basis by using the weight parameters (w) possessed by the individual neuron layers, and next executing the backward propagation processes sequentially at the individual neuron layers. Herein, a batch in the expression of “a batch-by-batch basis” represents a base unit of learning processing targets. For example, when the neural network recognizes the images, data of several tens through several thousands of images are used, as the base unit of the batch, for the learning process, and the image recognition and a determination of correct solution are iteratively executed.

The plurality of computing nodes 10 illustrated in FIG. 3 shares the processes of the batch of image data, whereby the learning processes are executed in parallel. A variation (Δw) of the weight parameter (w) is computed as a result of one-time learning process on the batch-by-batch basis. As described in FIG. 1, the weight parameter (w) is defined as a vector having one or more components. The weight parameter (w) will hereinafter be simply termed the weight (w). As described above, the variation (Δw) of the weight (w) is computed in such a direction as to decrease the error evaluation function (ERROR). Each computing node 10 mutually transfers and receives the computed results of the variation (Δw) of the weight (w) on the batch-by-batch basis on its own side, and the variations (Δw) of the weights (w) on the batch-by-batch basis on the side of other computing nodes 10, thereby integrating the mutually computed results. The process that the computing nodes 10 mutually integrate the variations (Δw) of the weights (w), may be said to be an aggregation process. Each computing node 10 executes a process of updating the weight (w) by using the variation (Δw) given as a result of the process of aggregating the mutually computed results. A phrase “updating the weight (w) of each layer by using the aggregation-processed variation (Δw)” may be said to be a phrase “reflecting the aggregation-processed variation (Δw) in the weight (w)”.

Three or more computing nodes 10 mutually transfer and receive the computed results, in which case the computing nodes 10 perform one-to-one communications a plural number of times. For example, when the computing nodes 10-1, 10-2, 10-3 and 10-4 mutually transfer and receive information by a butterfly method (Recursive Doubling), initially at a first transfer/reception, the computing node 10-1 and the computing node 10-2 transfer and receive the information; and the computing node 10-3 and the computing node 10-4 transfer and receive the information. Next, at a second transfer/reception, the computing node 10-1 and the computing node 10-3 transfer and receive the information; and the computing node 10-2 and the computing node 10-4 transfer and receive the information. With the information being transferred and received twice as described above, the transfers/receptions of the information among the computing nodes 10-1, 10-2, 10-3 and 10-4 are completed.

It does not mean that an inter-node communication algorithm is limited to the Recursive Doubling in the embodiment. For example, the inter-node communication algorithm may involve using methods instanced by Reduce+Broadcast (Bcast) and Reduce_scatter+Allgather. In this type of inter-node communication process, a computer program is provided as an MPI_AllReduce process (a process of Message Passing Interface_AllReduce). Note that the following discussion will describe the embodiment by using the computing node 10 implementing the MPI_AllReduce process, and it does not, however, mean that the communication process between the computing nodes 10 is limited to the MPI_AllReduce process. It does not mean that there is a limit to the network topology in which to execute the communication process between the computing nodes 10, and any type of network topology may be available.

### Comparative Example

In a comparative example, the respective neuron layers (e.g., the neuron layers 1-N) contained in the neural network illustrated in FIG. 2 are built up within each computing node 10. In other words, in the comparative example, the processes of the respective neuron layers are executed based on the computer program of the computing node 10. Note that the neuron layer N is written such as “Layer N” in the drawings used for the following description.

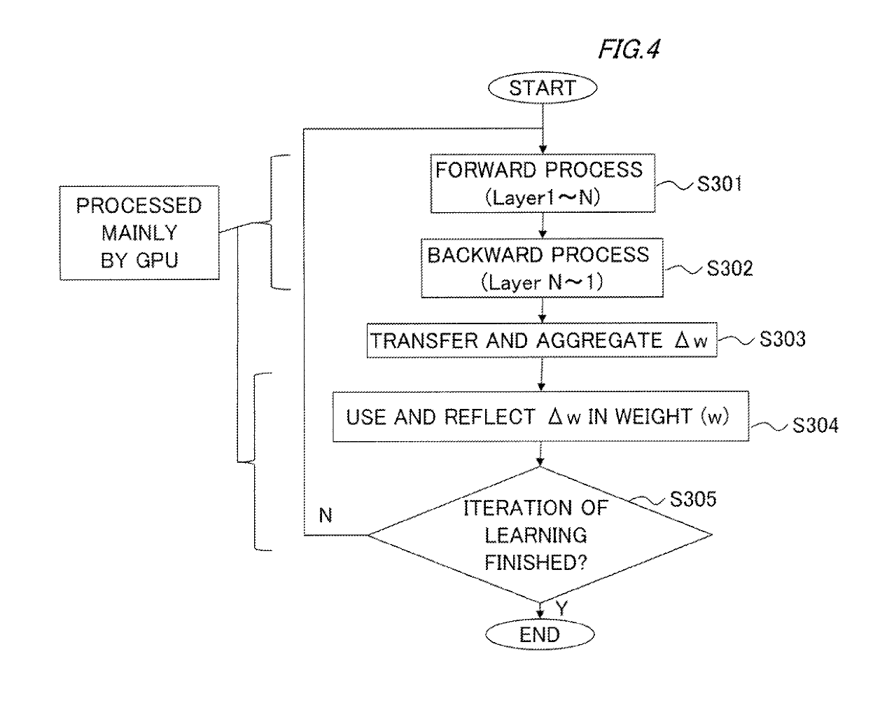

FIG. 4 illustrates processes according to the comparative example. In the comparative example, each computing node 10 executes the forward propagation processes and the backward propagation processes illustrated in FIG. 2. In the comparative example, the computing node 10 executes the forward propagation processes sequentially at all the neuron layers (the neuron layers 1 through N) (S301). Next, the computing node 10 executes the backward propagation processes sequentially at all the neuron layers (the neuron layers N through 1) (S302).

The respective computing nodes 10 mutually transfer the variations (Δw) of the weights (w) at the neuron layers 1-N, and integrate the mutually transferred computed results (the variations (Δw) of the weights (w) at the neuron layers 1-N). As described above, the process that each computing node 10 integrates the computed results of the computations by the respective computing nodes 10, is also termed “aggregation” (S303). Each computing node reflects the aggregation of the variations (Δw) of the weights (w) at the neuron layers 1-N in the weight (w) at each layer (S304). The computing node 10 determines whether the iteration of the learning process is finished (S305). The computing node 10, when an unlearned batch exists, loops the processing back to S301, and executes the learning process at the next batch (NO in S305). Whereas when all the batches are learned, the computing node 10 finishes processing (YES in S305).

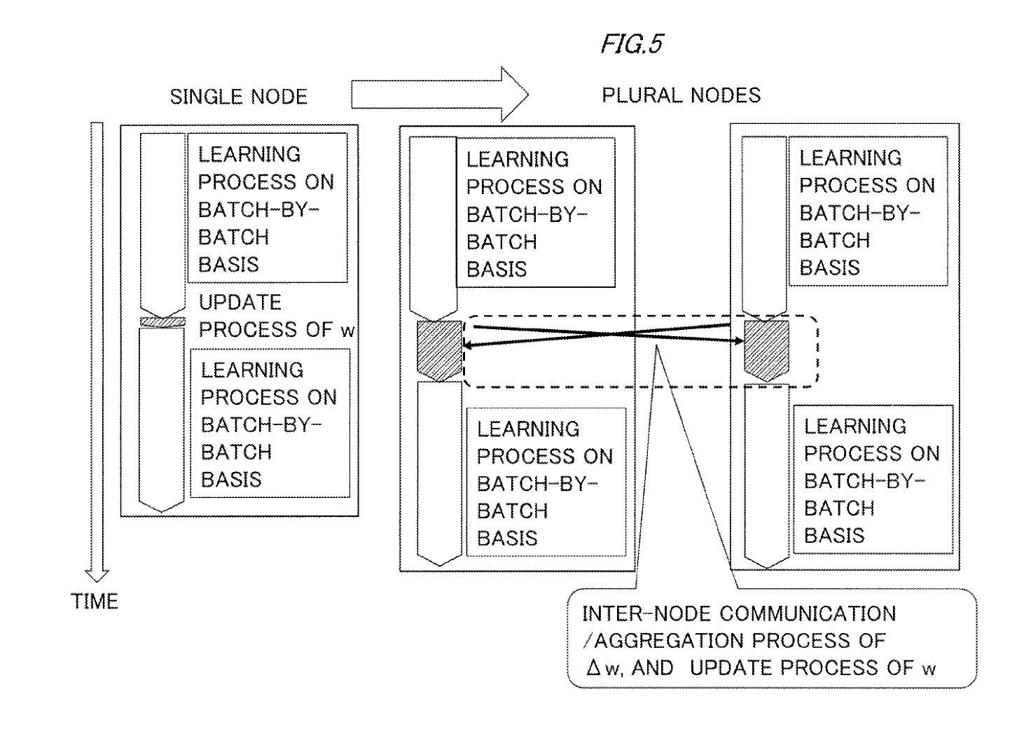

FIG. 5 is a time chart illustrating the processes in the comparative example. FIG. 5 also illustrates a process on the single node for a comparison. As depicted on a left side of FIG. 5, the process on the single node is to iterate the learning process on the batch-by-batch basis, the process of updating the weight (w) and the learning process on the batch-by-batch basis.

On the other hand, as depicted on a right side of FIG. 5, the plural nodes can execute the learning processes on the batch-by-batch basis in parallel a number of times corresponding to a number of the computing nodes 10. However, it follows that each computing node 10, upon finishing the learning process on the batch-by-batch basis, updates the weight (w) on each computing node 10 after transferring/receiving the variations (Δw) of the weights (w) through the inter-node communications and aggregating these variations (Δw). Accordingly, the processes according to the comparative example, even when increasing the number of the computing nodes 10, lead to a result of increasing time for the inter-node communication/aggregation process and the update process, and a result of not sufficiently exhibiting a time reduction effect of the learning process due to the increase in number of the computing nodes.

### Embodiment 1

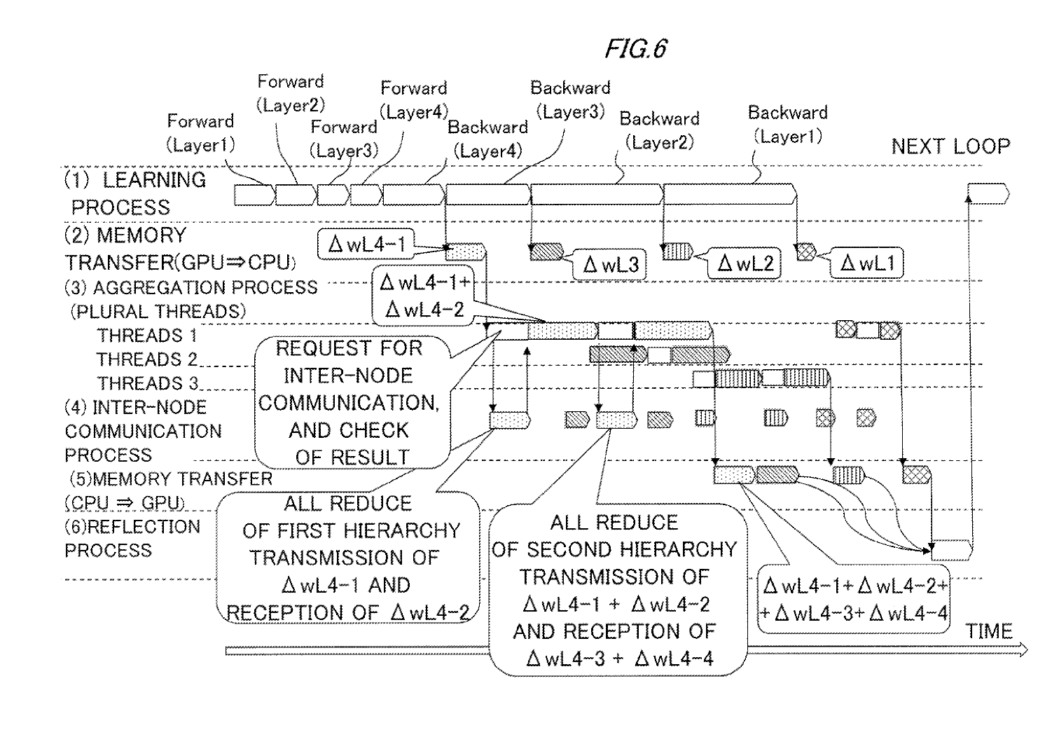

FIG. 6 is a time chart illustrating processes in an embodiment 1. It is noted that the GPU 13 in the components of the computing node 10 executes fast a product-sum operation used for graphics process. The GPU 13 is therefore capable of performing fast the computation using the weight (w), which becomes a main operation of the learning process. However, when mainly the arithmetic unit executes the learning process, the inter-node communication/aggregation process and the reflection process, a processing procedure is the same as in the flowchart of FIG. 4, and the time for transferring/receiving the variation (Δw) of the weight (w) through the inter-node communications and the time for executing the aggregation process and the reflection process are not ignorable.

Such being the case, the parallel information processing apparatus 1 according to the embodiment 1 includes the plurality of computing nodes 10 each equipped with an arithmetic unit (GPU 13) and a processing unit (CPU 11), in which the arithmetic unit (GPU 13) executes the learning process, while the processing unit (CPU 11) executes the communications, the aggregation process and the reflection process.

### (1) Learning Process

The learning process is executed mainly by the GPU 13. The learning process involves sequentially executing the forward propagation process and the backward propagation process per neuron layer (the sequence of the processes of the neuron layers is reversed to the sequence of the forward propagation processes). The plurality of computing nodes 10 shares the processes of the batch of image data, whereby the learning processes are executed in parallel. FIG. 6 illustrates neuron layers 1 (LAYER1) through 4 (LAYER4) as the neuron layers. The neuron layers 1 through 4 are one example of “a plurality of hierarchies”. The forward propagation process and the backward propagation process at each of the neuron layers 1 through 4 are one example of “layer-by-layer processes”. The forward propagation process and the backward propagation process at each of the neuron layers 1 through 4 are also one example of “a process of performing a computation using the coefficient about data input from a hierarchy previous to each hierarchy and outputting a computation result to a next hierarchy”. A sequence of executing the forward propagation processes sequentially from the neuron layer 1 down to the neuron layer 4 and executing the backward propagation processes sequentially from the neuron layer 4 up to the neuron layer 1, is one example of “a predetermined sequence”.

(2) Memory Transfer (Transfer from GPU 13 to CPU 11)

The arithmetic unit (GPU 13) transfers, from the memory 14 to the memory 12 of the processing unit (CPU 11), the variations (Δw) of the weights (w) computed at the respective neuron layer for the learning process sequentially per neuron layer finishing the learning process. With this transfer, the arithmetic unit (GPU 13) instructs the processing unit (CPU 11) to start the inter-node communication/aggregation process and the reflection process per neuron layer. The start of the next learning process on the batch-by-batch basis is accelerated to attain the acceleration by starting the inter-node communication/aggregation process and the reflection process per neuron layer.

Specifically, whenever each computing node 10 finishes the backward propagation process at each layer, a thread for the learning process assigned to the arithmetic unit (GPU 13) issues a queue for starting up a memory transfer. The queue can be also called a request. The processing thread for the memory transfer (the transfer from the memory 14 of the GPU 13 to the memory 12 of the CPU 11) transfers, upon receiving the queue, transfer target data to the CPU 11 from the GPU 13, and finally issues a queue for the aggregation process to the CPU 11. In FIG. 6, weight variations ΔWL4-1, ΔWL3, ΔWL2 and ΔWL1 are computed in the backward propagation processes at the neuron layer 4 (LAYER4) through the layer 1 (LAYER1) as the neuron layers.

### (3) Aggregation Process and (4) Inter-Node Communications

Each of a designated number (1 through several tens) of aggregation processing threads prepared beforehand, upon receiving the queue, at first issues the queue for the inter-node communication process. A thread for the inter-node communication process, upon receiving the queue for the inter-node communication process, inputs a Message Passing Interface (MPI) request for the inter-node communication to an MPI communication program by designating a non-blocking communication. Just when completing the communication corresponding to the request, the MPI communication program notifies the aggregation processing thread that the communication is completed, and the aggregation process is executed according to the aggregation processing thread. The aggregation process involves performing the computations a multiple number of times, and therefore attains the acceleration by running a plurality of threads in parallel. To be specific, when the computing node 10 is mounted with the plurality of CPUs 11, the CPUs 11 execute the parallel processing by running the plurality of threads in parallel. The same is applied to when the single CPU 11 has multicores.

In FIG. 6, in the first inter-node communication, e.g., the inter-node communication thread transmits ΔWL4-1 to another node and receives ΔWL4-2 from another node at the neuron layer 4 (LAYER4). An aggregation processing thread 1 integrates ΔWL4-1 and ΔWL4-2, thereby executing the aggregation process. Thus, ΔWL4-1+ΔWL4-2 is obtained by the aggregation process.

Next, in the second inter-node communication, e.g., the inter-node communication thread transmits ΔWL4-1+ΔWL4-2 to another node and receives ΔWL43+ΔWL4-4 from another node at the neuron layer 4 (LAYER4). The aggregation processing thread 1 integrates “ΔWL4-1+ΔWL4-2” and “ΔWL4-3+ΔWL4-4”, thereby executing the aggregation process. The threads 1-3 in FIG. 6 execute in parallel two or more aggregation processes for the variations of the coefficients at the respective hierarchies by way of one example.

(5) Memory Transfer (Transfer from CPU 11 to GPU 13)

Upon completing the inter-node communications performed such a number of times as to transfer/receive the information to/from all other nodes and completing the aggregation processes, the CPU 11 issues the queue for the memory transfer (transfer to the memory 14 of the GPU 13 from the memory 12 of the CPU 11) process. A memory transfer processing thread receives the queue and executes the memory transfer (transfer to the GPU 13 from the CPU 11).

### (6) Reflection Process

Upon completing the memory transfer (transfer to the GPU 13 from the CPU 11) at each layer, the reflection process mainly on the side of the GPU 13 is executed sequentially from the neuron layer with the memory transfer being completed.

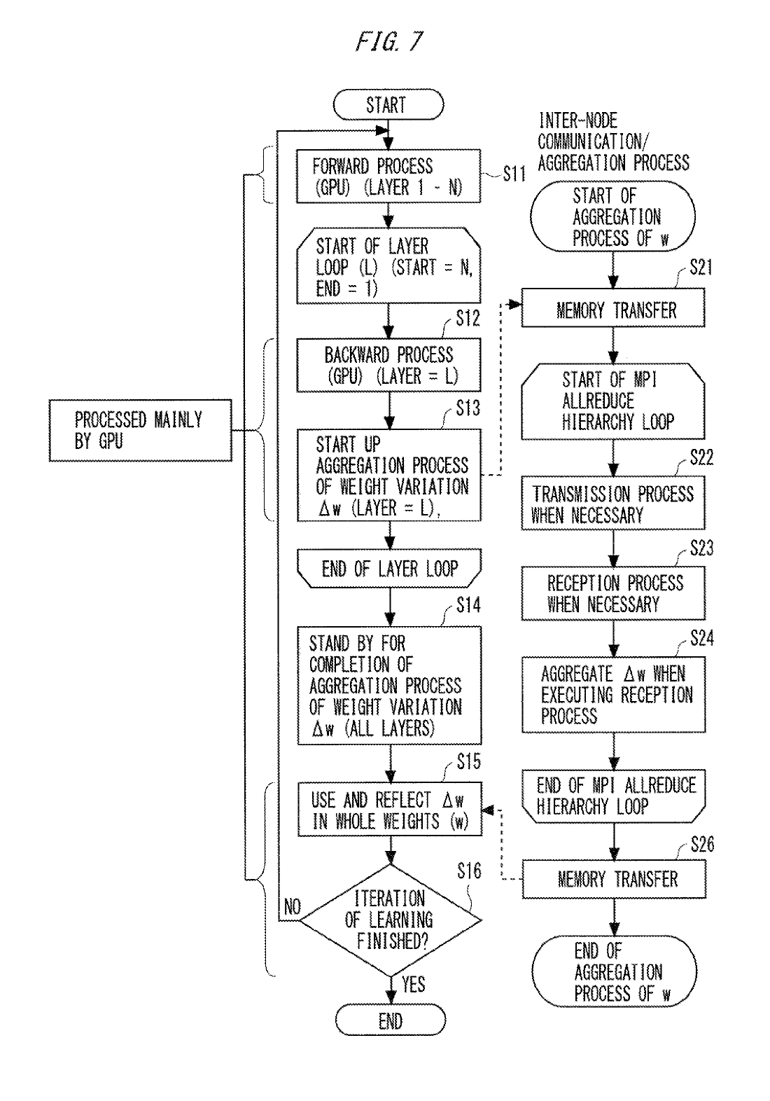

FIG. 7 is a flowchart illustrating the processes of the computing node 10 according to the embodiment 1. The flowchart on the left side in FIG. 7 illustrates the learning process and the reflection process that are executed mainly by the GPU 13. The flowchart on the right side in FIG. 7 illustrates the inter-node communication/aggregation process that is executed mainly by the CPU 11. In the processes of FIG. 7, to begin with, the GPU 13 executes the forward propagation processes at the neuron layers (e.g., the neuron layers 1-N) (S11).

The forward propagation process is, as illustrated in FIG. 1, the computation process using the input data and the weight (w). The computation process is exemplified by the convolution computation using the filters of the input data elements x (I, j) and the (m×m) number of weights W_{ab} (a, b=0, . . . , m−1), the pooling computation at the subsampling layer and the computation at the fully connected layer. The process in S11 is one example of “a computation process using a coefficient for processing target data”.

Next, the GPU 13 executes processes S12 and S13 in a loop (LAYER loop (L), start: L=N, end: L=1) of the neuron layers from layer N to layer 1 in the backward propagation. In the process of S12, at each neuron layer (L) in the backward propagation, the GPU 13 obtains the error evaluation function (ERROR) at the neuron layer (L) from the error evaluation function (ERROR) at a higher-order layer (L+1). The GPU 13 obtains the variation (Δw) of the weight (w) in such a direction as to decrease the error evaluation function (ERROR) of the neuron layer (L), based on the error evaluation function (ERROR) of the neuron layer (L). The process in S12 is one example of “computing a coefficient variation based on a result of the computation process”. The process in S12 is also one example of “computing the variation of the coefficient at each hierarchy, based on a result of a layer-by-layer process at each hierarchy”.

The process in S13 is a process of requesting the CPU 11 to start up the aggregation process of the variation (Δw) of the weight. With the process in S13, the GPU 13 transfers the variation (Δw) of the weight (w), which is computed with respect to the neuron layer (L) obtained in S12, to the CPU 11, and registers the queue in the thread of the CPU 11 that executes the aggregation process (S13). Accordingly, in the embodiment 1, each time the backward propagation process is finished at each neuron layer (L), the CPU 11 is requested to start up the aggregation process of the variation (Δw) of the weight (w). The process in S13 is one example of “transferring a computed coefficient variation of to a second processor, and requesting the second processor to execute a transfer/receipt process of transferring the coefficient variation to another node of the parallel information processing apparatus and receiving a coefficient variation computed by another node”. The process in S13 is also one example of “transferring the computed variation of the coefficient to the second processor”.

Hereafter, the GPU 13 waits for the CPU 11 to complete the aggregation processes of the variations (Δw) of the weights (w), which correspond to the number of all the neuron layers (S14). The variations (Δw) of the weights (w) at the respective neuron layers (L), which variations are aggregation-processed by the CPU 11, are memory-transferred to the GPU 13 from the CPU 11. Upon completing the aggregation processes of all the layers, the GPU 13 reflects the aggregation-processed variations (Δw) in the weights (w) of the respective layers (S15). In other words, the GPU 13 updates the weight (w) of each layer, which is used in the forward propagation processes and the backward propagation processes of the next batch. The process in S15 is one example of “the first processor updating the coefficient to be used in the computation process from next time onward, based on the integrated coefficient variation”.

The GPU 13 determines whether the learning is finished (S16). The finish of the learning implies, e.g. a finish of all the batches prepared for the computing nodes 10. There remain unlearned batches prepared for the computing nodes 10, in which case the GPU 13 loops back the processing to S11, and executes the next batch.

With the process in S13, the CPU 11 is requested to start up the aggregation process, and the queues are registered in the threads of the CPU 11 and sequentially processed. The CPU 11 executes at first the memory transfer, and acquires the variation (Δw) of the weight (w) of the neuron layer (L), which is computed by the GPU 13 (S21). Then variations (Δw) of the weight (w) of the neuron layer (L) are transferred and received to and from other computing nodes 10. As described above, according to the embodiment 1, a process of exchanging the data between the nodes involves using the ALLReduce algorithm based on MPI specifications. It does not, however, mean that the process of exchanging the data between the nodes in the embodiment 1 is limited to the ALLReduce algorithm. In FIG. 7, the CPU 11 iteratively executes the processes in S22 through S24 in the hierarchical loop of MPI ALLReduce.

For example, when the node count is “4” (the computing nodes 10-1 through 10-4), the following processes are executed in the case of Recursive Doubling. The CPU 11 executes the processes in S22 through S24 in each of a couple of the computing nodes 10-1, 10-2 and another couple of the computing nodes 10-3, 10-4, respectively. To be specific, the variation (Δw) of the weight (w), which is computed by the self node, is transmitted to an exchange target node (S22). The process in S22 is one example of “transmitting the coefficient variation transferred from the first processor to another node”.

The CPU 11 receives another variation (Δw) of the weight (w) of the neuron layer (L), which is computed by the exchange target node (S23). The process in S23 is one example of “receiving the coefficient variation computed by another node”. The processes in S22 and S23 are therefore one example of “a communication process”.

The CPU 11 integrates the variation (Δw), computed by the self node, of the weight (w) of the neuron layer L and the variation (Δw), computed by the exchange target node, of the weight (w) of the neuron layer L (S24). The process in S24 is one example of “an aggregation process of integrating the coefficient variation transferred from the first processor and the coefficient variation computed by another node”.

Further, the CPU 11 executes the processes in S22 through S24 in each of the couple of the computing nodes 10-1, 10-3 and another couple of the computing nodes 10-2, 10-4, respectively. By this process, the variations (Δw) of the weights (w) of the neuron layers L are aggregated among the computing nodes 10-1 through 10-4. When aggregating the variations (Δw) of the weights (w) of the neuron layers L, the CPU 11 memory-transfers the aggregated variations (Δw) of the weights (w) of the neuron layers L, and returns the processing to the GPU 13 (S26). The computing node 10 iteratively executes the processes in S21 through S26 with respect to all the neuron layers L in an accumulated sequence of the queues.

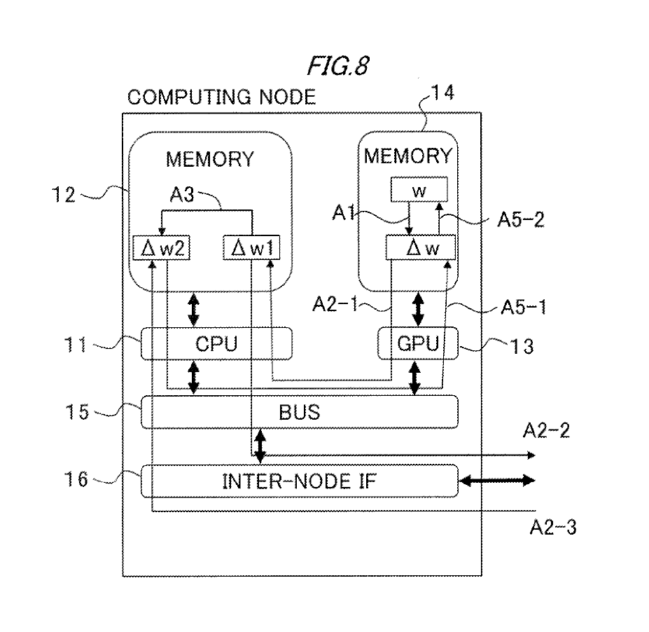

FIG. 8 illustrates a data flow in the computing node 10 according to the embodiment 1. In the computing node 10, to start with, in the learning process by the GPU 13, the computed result by the GPU 13 is stored in the memory 14 of the GPU 13 (arrowed line A1). As described above, the computed result is the variation (Δw) of the weight (w) of the neuron layer L.

Next, the inter-node communication process is executed. At first, the memory-transfer is carried out between the GPU 13 and the CPU 11, whereby the variation (Δw), stored in the memory 14, of the weight (w) of the neuron layer L is transferred to the memory 12 of the CPU 11 (arrowed line A2-1). Herein, let “Δw1” be the variation of the weight (w), which is stored in the memory 12. The variation (Δw1) of the weight (w), which is stored in the memory 12, is transmitted to another computing node 10 via the inter-node IF (arrowed line A2-2). On the other hand, the computing node 10 receives a variation (Δw2) of the weight (w) of the neuron layer L via the inter-node IF, which is computed by another computing node 10 (arrowed line A2-3).

The aggregation process is further executed (arrowed line A3). In the aggregation process, the CPU 11 adds the data (the variations Δw1 and Δw2) of the memory 12. Herein, an added result is to be retained in Δw2 as the aggregated variation of the weight. When the node count is “3” or more, the processes indicated by the arrowed lines A2-2 through A3 are iterated a corresponding number of times to the executions by the inter-node communication algorithm.

The CPU 11 memory-transfers the aggregated variation (Δw2) of the weight (w) of the neuron layer L to the GPU 13 (arrowed line A5-1). The transfer destination GPU 13 saves the transferred weight variation in the variation (Δw). The GPU 13 updates the weight (w) by using the aggregated variation (Δw) of the weight (w) of the neuron layer L (A5-2).

As described above, the parallel information processing apparatus 1 according to the embodiment 1 executes the learning processes of the weights (w) in parallel in order for the plurality of computing nodes 10 to compute the weights (w) for the input data on the batch-by-batch basis at the plurality of neuron layers. The variations (Δw) of the weights (w) obtained by the learning processes executed in parallel are aggregated among the plural computing nodes 10, and each computing node 10 acquires the weight (w) in which results of the batches of all the computing nodes 10 are reflected with respect to the neuron layers.

In the process described above, in each computing node 10, the GPU 13 sequentially executes the learning processes of the respective neuron layers. To be specific, the GPU 13 performs the computations using the weights (w) with respect to the neuron layers 1 through N in the forward propagation. Next, the GPU 13 executes the process of computing the variation (Δw) of the weight (w) of each neuron layer L with respect to the neuron layers N through 1 in the backward propagation. Whenever finishing the computation of the variation (Δw) of the weight (w) of each neuron layer L, the GPU 13 memory-transfers the computed variation (Δw) of the weight (w) to the CPU 11, and requests the CPU 11 for the aggregation process by issuing the queue for the aggregation process to the thread of the CPU 11.

As discussed above, the GPU 13 capable of performing fast the computations, instanced by the product-sum operation, using the weights (w) executes the learning processes in parallel in the plurality of computing nodes 10, and the CPU 11 memory-transfers the variation (Δw) of the weight, performs the inter-node communications and executes the aggregation process. It may be therefore sufficient that the GPU 13 executes exclusively the learning process in cooperation with the CPU 11, thereby facilitating an exhibition of computing performance of the GPU 13.

The CPU 11, upon receiving the request for the aggregation process, performs the inter-node communications in the sequence of the queues. Based on the ALLReduce algorithm, the CPU 11 transmits, e.g., the variation (Δw), computed by the self node, of the weight (w) to other computing nodes 10, and receives the computed results obtained from other computing nodes 10. The CPU 11 sequentially aggregates the variations (Δw) of the weights (w) per neuron layer. Accordingly, compared to the comparative example of FIG. 4, the aggregation process of each layer is started earlier than executing the process of aggregating the variations (Δw) of the weights (w) after completing the backward propagation processes with respect to all the neuron layers as in FIG. 4 illustrating the comparative example. For example, the CPU 11 takes the multicore configuration, as in FIG. 6, in which case the aggregation processes of the different neuron layers are assigned separately to the plurality of threads, whereby the aggregation processes of the plurality of neuron layers are executed in parallel.

The inter-node communication of another neuron layer L+1 can be performed in parallel during the execution of the aggregation process of a certain neuron layer L. The plurality of threads for the aggregation processes can execute the aggregation processes and the inter-node communication processes in parallel with respect to the plurality of layers L+1, L+2, L+3, while the memory transfer thread memory-transfers the result of the aggregation process of the neuron layer L to the GPU 13. The comparative example illustrated in FIG. 5 involves executing the learning processes on the batch-by-batch basis with respect to all the neuron layers, executing the aggregation processes with respect to all the neuron layers, and executing the next learning process with respect to all the neuron layers. By contrast with such processing in the comparative example, the computing node 10 according to the embodiment 1 has a reduction in processing time of at least the aggregation process. The start of the forward propagation processes of the next batch can be accelerated.

### Embodiment 2

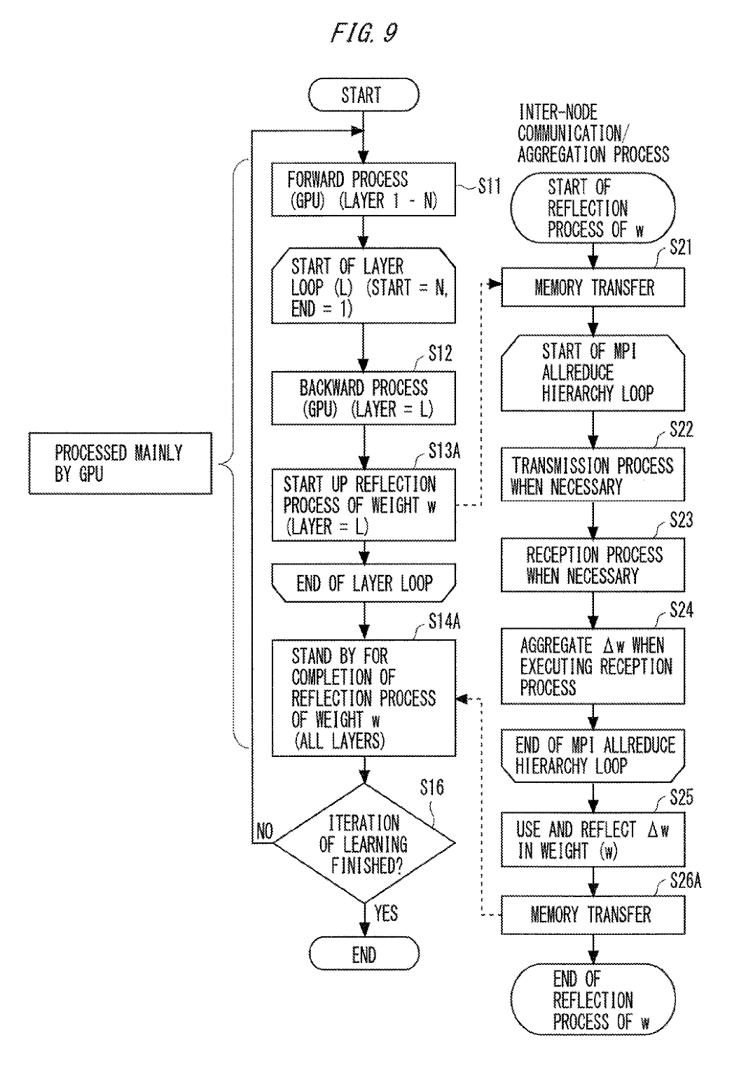

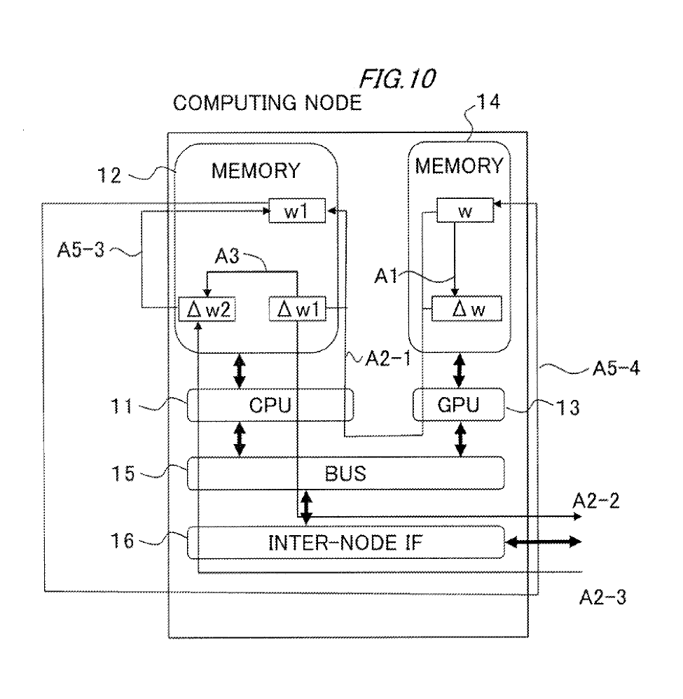

The parallel information processing apparatus 1 according an embodiment 2 will be described with reference to FIGS. 9 and 10. In the parallel information processing apparatus 1 according to the embodiment 2, the CPU 11 executes the “(6) reflection process” illustrated in FIG. 6 on a per neuron layer basis. Then, the CPU 11 executes (5) the memory transfer (to GPU 13 from the CPU 11) after the reflection process on the per neuron layer basis. Other configurations and operations of the embodiment 2 are the same as those of the embodiment 1. This being the case, the same components of the parallel information processing apparatus 1 according to the embodiment 2 as those of the embodiment 1 are marked with the same numerals and symbols, and the repetitive explanations thereof are omitted.

FIG. 9 is a flowchart illustrating processes of the computing node 10 according to the embodiment 2. The processes in FIG. 9 are different from FIG. 7 in terms of a point that the process of reflecting the variation (Δw) in the weight (w) is executed not by the GPU 13 but by the CPU 11. For example, in FIG. 9, a process in S25 is added to the inter-node communication/aggregation process.

At first, the GPU 13 starts up the process of reflecting the variation (Δw) computed by the learning process in the weight (w) (S13A). Hereat, such a point is the same as in FIG. 7 that the variation (Δw) of the weight (w) of the neuron layer is transmitted to the CPU 11 from the GPU 13 in the memory transfer process. The GPU 13 memory-transfers the variations (Δw) in a priority order of the queues (S21), and executes the aggregation process (S22-S24). Upon a finish of the MPI ALLReduce hierarchy loop, the CPU 11 reflects, in the weight (w), the aggregation-processed variation (Δw) of the weight (w) of a certain neuron layer L (S25). The process in S25 is one example of “a second processor updating the coefficient used in the computation process from next time onward, based on the integrated variation of the coefficient”.

The CPU 11 transmits, to the GPU 13, the weight (w) in which the CPU 11 has already reflected the variation (Δw) by the memory transfer (S26A). The GPU 13 receives the weight (w) in which the CPU 11 has already reflected the variation (Δw) by the memory transfer, and stores the received weight (w) in the memory 14 (S14A). The GPU 13, when there remain the unlearned batches (N in S16), executes learning the next batch of the input images.

FIG. 10 illustrates a data flow in the computing node 10 according to the embodiment 2. In processes of FIG. 10, the learning process (arrowed line A1), the inter-node communication process (A2-2, A2-3) and the aggregation process (arrowed line A3) are the same as those in FIG. 8. However, in the memory transfer (arrowed line A2-1) before the inter-node communication process, the CPU 11 receives the weight (w) together with the variation (Δw) of the weight from the GPU 13, and stores the received weight as a weight (w1) in the memory 12.

The CPU 11, after the aggregation process of the variation (Δw) of the weight, reflects the aggregated variation (Δw) (illustrated by Δw1 and Δw2 in FIG. 10) of the weight in the weight (w), and stores the weight as the weight (w1) in the memory 12 (arrowed line A5-3). The CPU 11 transfers, to the GPU, the weight (w1) in which to the CPU has already reflected the variation (Δw) of the weight by the memory transfer, and saves the transferred weight as the weight (w) in the memory 14 (arrowed line A5-4).

As described above, according to the embodiment 2, the CPU 11 executes the process of reflecting the variation (Δw) in the weight (w). This configuration and procedure enable the GPU 13 to further devote itself to computing the variation (Δw) of the weight. The threads for the reflection processes execute the parallel processing, corresponding to the number of cores of the CPU 11 as in the case of the aggregation processes, whereby the learning processes can be executed fast.

### Embodiment 3

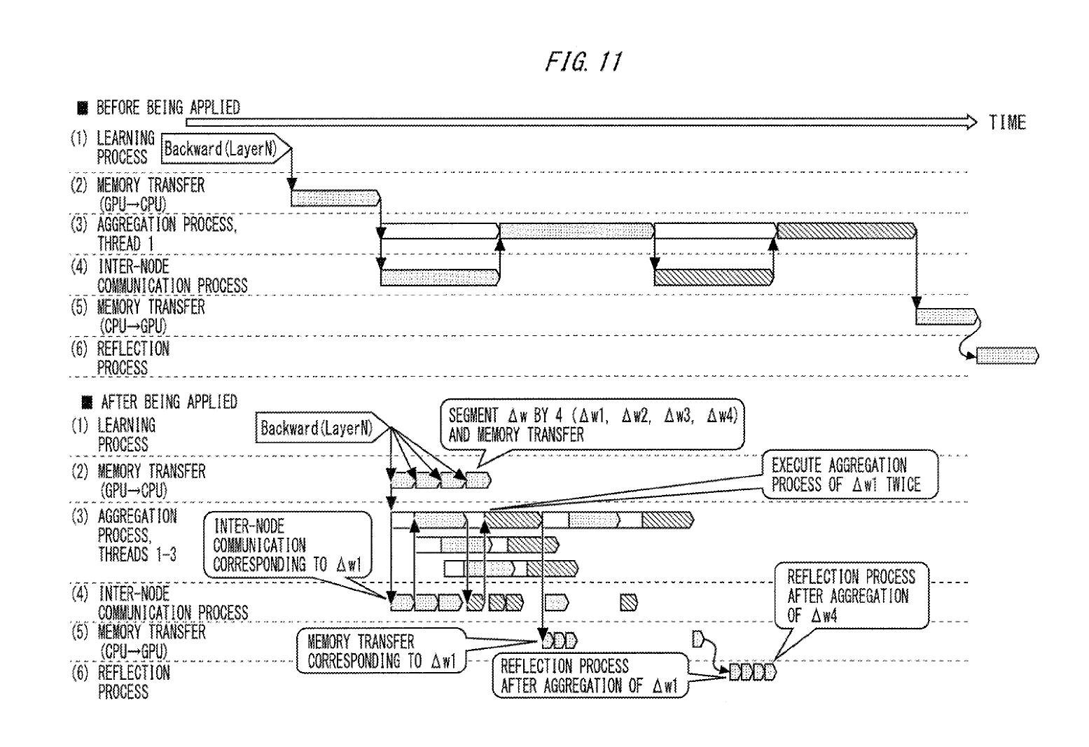

The parallel information processing apparatus 1 according to an embodiment 3 will be described with reference to FIGS. 11 through 13. In the embodiment 1, the CPU 11, when executing the inter-node communication/aggregation process of the learned results, divides the inter-node communication/aggregation process on the per neuron layer basis. To be specific, the CPU 11 individually executes the inter-node communication/aggregation process of the learned result with respect to one neuron layer, and, each time the variations (Δw) of the weights of the respective neuron layers are aggregated, memory-transfers the aggregated variation to the GPU 13. In the embodiment 2, the CPU 11 reflects the weight variation (Δw) in the weight (w), and memory-transfers the variation-reflected weight to the GPU 13. However, in the processes according to the embodiments 1 and 2, the transfer process takes a considerable period of time when one neuron layer has weights of a large number of parameters, and a parallelization effect is not exhibited as the case may be even when the multicore CPU 11 has the configuration that the plurality of threads executes the parallel processes. Such being the case, according to the embodiment 3, the GPU 13 and the CPU 11 execute processing by dividing more minutely a base unit of execution of the inter-node communication thread, the plurality of aggregation process threads and the reflection process thread than the base unit of the neuron layer. With such a procedure, the computing node 10 pipelines the respective processes, thus accelerating the processing.

For example, the weight (w) of a certain neuron layer L is assumed to be a parameter string instanced by w=(p1, p2, . . . , pX). The parameter string is one example of “a coefficient string”. In other words, a plurality of weights (w) of the neuron layer is used to form the coefficient string. It is assumed that the variation (Δw) of the weight is computed as a string of multiple parameters given such as Δw=(Δp1, Δp2, . . . , ΔpX) as a result of the learning process. In this case, the GPU 13 segments the variation (Δw) into segment strings such as Δw1=(Δp1, Δp2, . . . , ΔpX1), Δw2=(ΔpX1+1, . . . , ΔpX2), Δw3=(ΔpX2+1, . . . , ΔpX3), . . . , Δwx=(ΔpX3+1, . . . , ΔpX).

FIG. 11 is a time chart illustrating the processes according to the embodiment 3. Note that FIG. 11 illustrates a time chart (“BEFORE BEING APPLIED”) before applying the processes according to the embodiment 3 together with a time chart (“AFTER BEING APPLIED”) when applying the processes according to the embodiment 3. In a pre-applying example (given on an upper side in FIG. 11), after finishing the backward propagation process with respect to the neuron layer N, the memory transfer from the GPU 13 to the CPU 11 is carried out, and thereafter a thread 1 executes the aggregation process together with the inter-node communication (e.g., the ALLReduce algorithm) performed twice.

On the other hand, in a post-applying example (given on a lower side in FIG. 11), after finishing the backward propagation process with respect to the neuron layer N, the GPU 13 segments the weight variation (Δw, parameter string) into segment strings such as Δw1, Δw2, Δw3, Δw4, and memory-transfers the segmented variations to the CPU 11.

The CPU 11 acquires the segmented variations Δw1, Δw2, Δw3, Δw4 by the memory transfer, and the threads 1-3 for the aggregation processes sequentially start up the aggregation processes. For example, the thread 1 at first, upon receiving the segmented variation (Δw1), starts up the thread of the inter-node communication process. The thread of the inter-node communication process transmits the segmented variation (Δw1) to another computing node 10-2, and receives another segmented variation (Δw1) of the neuron layer N from the computing node 10-2. Now, let Δw1-1 be the variation computed by the self node and Δw1-2 be the variation computed by the computing node 10-2 in order to distinguish the variation Δw1 between the self node and another node. The thread 1 integrates the segmented variation (Δw1-1) computed by the self node and the segmented variation (Δw1-2) obtained by the inter-node communication process and computed by another node, and executes the aggregation process between the computing node 10-2 and the self node. Hereat, in parallel with the aggregation process of the thread 1, the thread 2 already starts up the thread of the inter-node communication process about the segmented variation (Δw2), and pipeline-executes the inter-node communication process and the aggregation process in the same way as by the thread 1. The thread 3 also pipeline-executes the inter-node communication process and the aggregation process in the same way as by the threads 1, 2.

The thread 1, upon completing the aggregation process between the weight variation (Δw1-1) computed by the self node and the weight variation (Δw1-2) computed by another node, again starts up the thread of the inter-node communication process, and executes the aggregation process between the computing node 10-3 and the self node. Each of the threads 2, 3, upon finishing the first aggregation process, again starts up the thread of the inter-node communication process, and executes the aggregation process between the computing node 10-3 and the self node in the same way as by the thread 1.

For example, the thread 1, upon completing the aggregation processes with respect to the segmented variations (Δw1) between all other computing nodes 10 and the self node, starts up a memory transfer thread. With the aid of the memory transfer thread, the CPU 11 transfers the aggregated variations (Δw1) to the GPU 13. The same operation is applied to the threads 2, 3.

The thread 1, upon issuing the queue for the memory transfer thread with respect to the segmented variation (Δw1), executes the same processes about the next segmented variation (Δw4) as those about the segmented variation (Δw1). Thus, the CPU 11 has a plurality of cores, e.g., five cores, in which case the CPU 11 can run the threads 1-3, the memory transfer thread and the inter-node communication thread in parallel. Accordingly, e.g., the inter-node communication process about a certain segmented variation (Δwk) can be executed in the time of the aggregation process about another segmented variation (Δwj). Supposing that parameter count of a weight (wL) of a certain neuron layer L is larger than the parameter counts of other layers, the GPU 13 and the CPU 11 segment the parameters contained in the weight (wL) into a plurality of parameter sets, and these parameter sets can be processed in parallel by the plurality of threads.

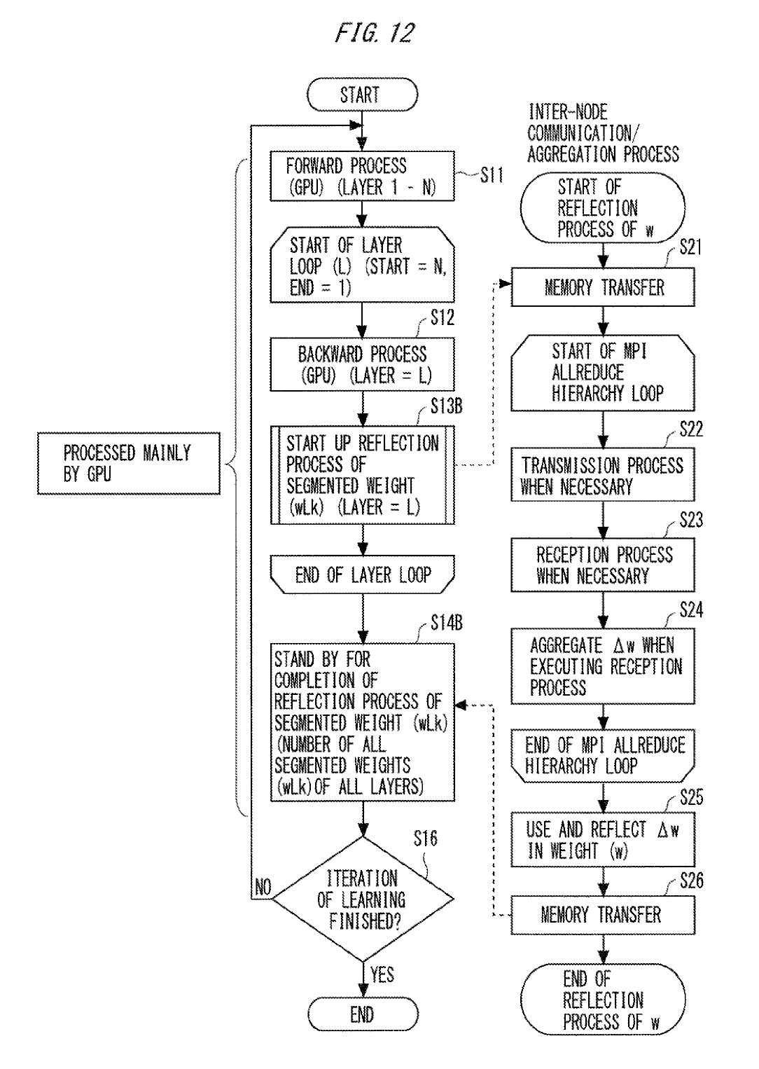

FIG. 12 is a flowchart illustrating the processes of the computing node 10 according to the embodiment 3. The processes in FIG. 12 are different from the processes in FIG. 9 in terms of starting up the reflection process and standing by for the reflection process. Specifically, in the embodiment 3, as described in FIG. 11, the GPU 13 segments the weight variation (ΔwL) of each neuron layer L into a plurality of segmented variations (ΔwLk, where “k” represents a number corresponding to a segment string being segmented) in a neuron layer loop. The GPU 13 conducts the memory transfer, and starts up the aggregation process and the reflection process per segment string (S13B). After finishing the neuron layer loop, the GPU 13 stands by for completing the reflection process of the segmented weight variation (ΔwLk) (S14B). Upon finishing the reflection processes with respect to all the segmented weight variations (ΔwLk) of all the neuron layers, the GPU 13 determines whether an iteration of the learning is finished, and executes learning the next batch of the input images by looping the processing back to S11 when there remain the unlearned batches.

Note that the processing flow in FIG. 12 is a modification of the processing flow in FIG. 9, in which the CPU 11 executes the reflection process of updating the weight (wLk) based on the weight variation (ΔwLk). As illustrated in FIG. 7, however, the CPU 11 memory-transfers the weight variation (ΔwLk) to the GPU 13, and the GPU 13 may execute the reflection process.

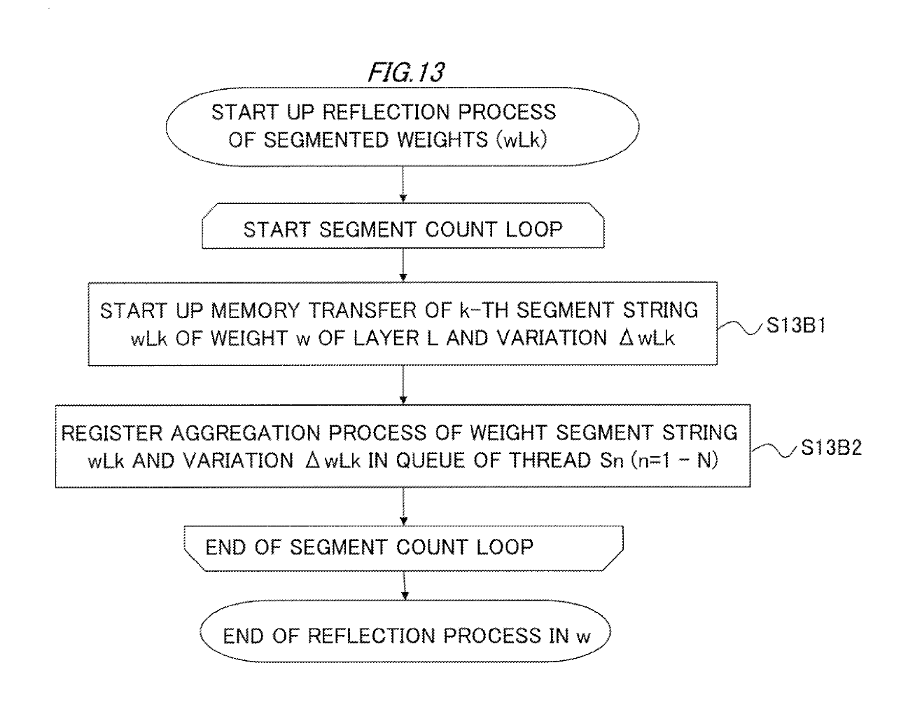

FIG. 13 is a flowchart illustrating details of the process (13A in FIG. 12), in which the GPU 13 according to the embodiment 3 starts up the reflection process of the segmented weight (wLk). In this process, the GPU 13 starts up the memory transfer of the segment string (wLk) of the k-th segment weight of the weight (wL) of the layer L and the weight variation (ΔwLk) (S13B1). The process in S13B1 is one example of “segmenting a coefficient string of each of the plurality of hierarchies into a plurality of segment strings and transferring a coefficient variation per segment string to a second processor”.

Next, the GPU 13 registers the aggregation process of the variation (ΔwLk) of the segment string (wLk) of the segmented weight and the reflection process of reflecting in the weight segment string (wLk) in queues of threads Sn (n=1 through N) (S13B2). The process of S13B2 is one example of “requesting the second processor to execute the transfer/receipt process per segment string”.

As discussed above, the parallel information processing apparatus 1 according to the embodiment 3 enables the plurality of threads to execute the memory transfer (to the CPU 11 from the GPU 13), the inter-node communication process, the aggregation process, the reflection process and the memory transfer (to the GPU 13 from the CPU 11). The GPU 13 according to the embodiment 3 segments the weight parameter string (wL) of the neuron layer L into the plurality of segment strings (wLk, k=1, 2, 3, . . . ). The GPU 13 starts up the memory transfer, the aggregation process and the reflection process per segment string (ΔwLk, k=1, 2, 3, . . . ) of each weight variation. The CPU 11 executes the memory transfer (to the CPU 11 from the GPU 13), the aggregation process, the reflection process and the memory transfer (to the GPU 13 from the CPU 11) per segment string (ΔwLk, k=1, 2, 3, . . . ) of the weight variation. Therefore, even when there is a large number of parameters contained in the weight (w) of the neuron layer, the memory transfer, the inter-node communication process and the aggregation process are pipelined, thereby enabling the time of the aggregation process to hide the time (or part of the time) required for the inter-node communication process. Note that the weight parameter string (wL) is one example of “the coefficient string”.

### Embodiment 4

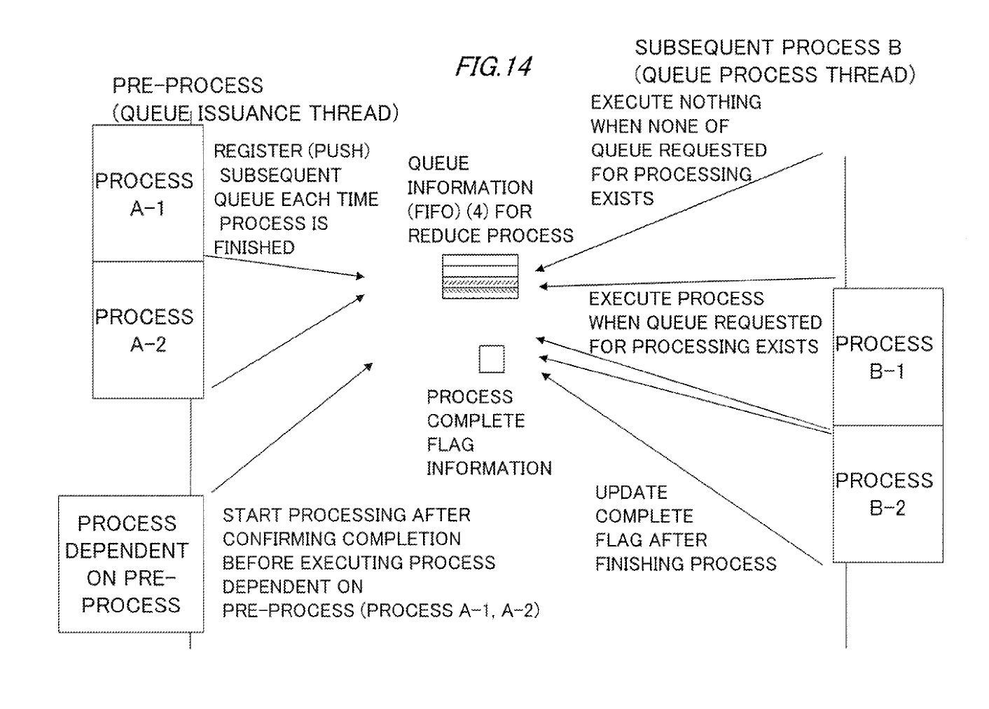

An embodiment 4 will described with reference to FIGS. 14 through 18. In the embodiments 1 through 3, e.g., the data per neuron layer are memory-transferred in the finishing sequence of the learning processes, and there are executed the inter-node communication process, the aggregation process and the reflection process. According to the embodiment 4, each thread controls issuance of the queue so that the priority order is lowered as the hierarchy rises by raising the priority order of a lowest layer of the hierarchy in the neuron layers, which lowest layer is, i.e., the layer (e.g., the neuron layer 1) receiving the input of the image in FIG. 2. This process enables a start of the next batch at the neuron layer that is the lowest of hierarchy when the variation (Δw) is already reflected in the weight (w) of the neuron layer that is low of hierarchy of a current batch before finishing all layers of the hierarchy of the current batch which is scheduled to be processed before the next batch.

FIG. 14 is a diagram illustrating queue information used for a Reduce process. The queue information is issued from a process (which is also said to be a pre-process and a queue information issuance thread) of issuing the queue information, and is processed by a subsequent process (which is also said to be a queue process thread). FIG. 14 illustrates a process A-1 and a process A-2 as the pre-processes. FIG. 14 also illustrates a process B-1 and a process B-2 as the subsequent processes.

In the example of FIG. 14, the pre-process (the queue issuance thread) registers the queue for the subsequent process each time the process is finished. The subsequent process (the queue process thread) executes nothing when there exists none of the queue requested to be processed. Whereas when the queue requested to be processed exists, the subsequent process (the queue process thread) executes the requested process, and updates process complete flag information upon finishing the process. The process complete flag information is exemplified by a counter to count a number of the completed processes (or a number of uncompleted processes). Note that a certain pre-process depends on the pre-processes (e.g., the process A-1 and the process A-2) to be executed earlier, in which case the processing is started after confirming completion of the dependent pre-processes before executing the processing.

The subsequent process (the queue process thread) executes the processing in a registered sequence of the queues in the manner described above. The embodiment 4 will hereinafter exemplify priority control of a sequence of registering the queues in a predetermined priority order, specifically a control procedure of executing the processes by prioritizing the lower neuron layers of hierarchy.

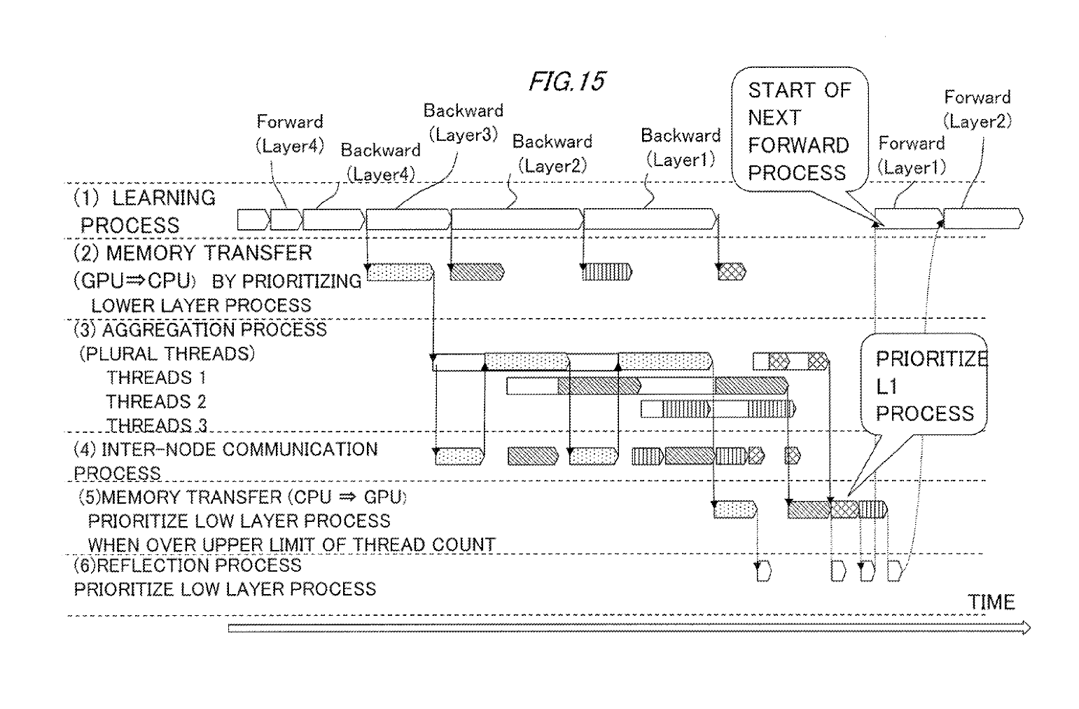

FIG. 15 is a time chart illustrating processes according to the embodiment 4. In FIG. 15, neuron layers 1 through 4 are assumed as the neuron layers. It does not, however, mean that the neuron layers according to the embodiment 4 are limited to the four neuron layers. When the backward propagation processes are respectively finished in the sequence from the neuron layer 4 up to the neuron layer 1, the memory transfer process is started up in this finishing sequence, thereby executing the inter-node communication process and the aggregation process. The memory transfer (to the GPU 13 from the CPU 11) is executed after completing the aggregation process of each neuron layer.

It is noted, in the example of FIG. 15, when the aggregated weight variation of the neuron layer 1 can be memory-transferred to the GPU 13 from the CPU 11, the memory transfer process of the aggregated variation of the neuron layer 2 is not yet started up. For example, the memory transfer process (to the GPU 13 from the CPU 11) of the neuron layer 2 is in an unexecuted status in a state of the queue being registered. According to the embodiment 4, upon finishing the aggregation process of the neuron layer 1 in this case, the aggregation process thread prioritizes the memory transfer of the neuron layer 1 over the neuron layer 2. To be specific, the aggregation process thread of the CPU 11 registers the queue of the memory transfer of the aggregated variation of the neuron layer 1 so that the aggregated variation of the neuron layer 1 is transferred in advance of the neuron layer 2. As a result of such a queue registration, the memory transfer thread memory-transfers the weight variation of the neuron layer 1 in advance of the neuron layer 2.

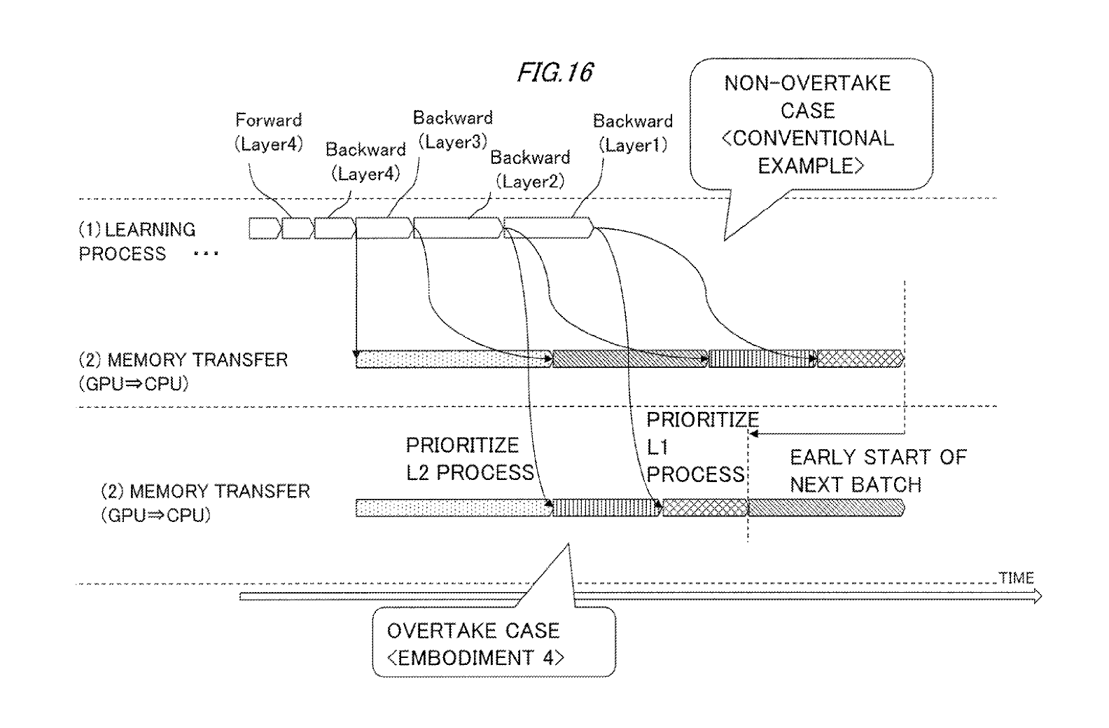

FIG. 16 is a time chart of a processing example of prioritizing the layers 1, 2 over the layer 3 with respect to the memory transfer after the learning process. In this time chart, the learning of the neuron layer 3 and the neuron layer 2 is completed during the memory transfer of the neuron layer 4 in the backward propagation processes. In this case, the memory transfer is started by prioritizing the neuron layer 2 closer in hierarchy to the input data over the neuron layer 3.

The learning process of the neuron layer 1 is completed during the memory transfer of the neuron layer 2. The memory transfer is started by prioritizing the neuron layer 1 closer in hierarchy to the input data over the neuron layer 3. Thereafter, the memory transfer of the neuron layer 3 is started.

The memory transfer is executed by giving a first priority to the neuron layer 1 receiving the input of the input data and prioritizing the layers in the sequence of being closer to the neuron layer 1, with the result that the neuron layer 1 is given the first priority and other layers are prioritized in the sequence of being closer to the neuron layer 1 when thereafter executing the inter-node communication process, the aggregation process and the reflection process. Accordingly, after finishing learning the current batch, a learning result of the current batch is reflected in the weight (w) in the priority order from the neuron layer 1 in preparation for the next batch. Therefore, even before completing the processes of all the neuron layers of the current batch, the GPU 13 can start the learning from the neuron layer 1 at the next batch, thereby accelerating start timing of the next batch on the whole.

As in FIGS. 15 and 16, for raising the priority order of the process of the neuron layer that is low of hierarchy, the processing sequence is changed on the base unit of the MPI ALLReduce hierarchy loop or the base unit of the segment string after segmenting the weight parameters in the embodiment 3. Each process thread registers the queue normally by a First In First Out (FIFO) method when registering the queue in the next thread. On the other hand, in the embodiment 4, each process thread registers the queue in a position of the priority order when detecting a change condition (the queue is not in a status of the priority order) of the processing sequence.

An inter-node transfer is locked when the processing sequence of the node with the processing sequence being changed deviates from the processing sequence of other nodes due to the change of the processing sequence of one node, and hence the computing nodes 10 synchronize with each other. A synchronizing method is that the computing node 10 detecting the change of the processing sequence distributes this change of the processing sequence to all other nodes, and each node similarly reorganizes the processing sequence, corresponding to the change of the processing sequence of the node concerned.

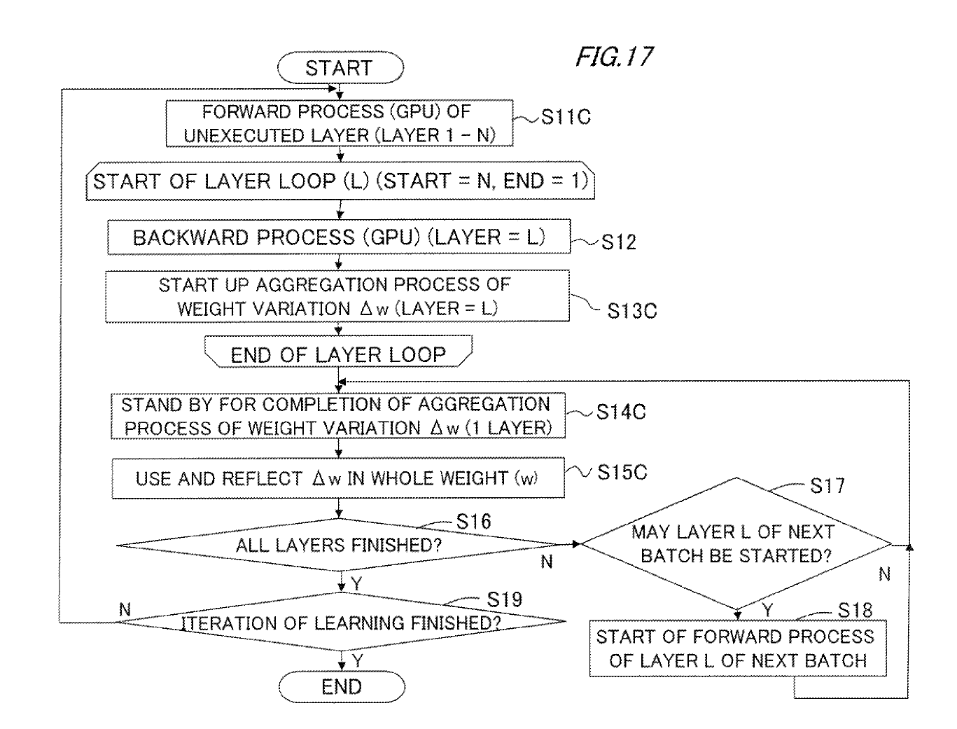

FIG. 17 is a flowchart illustrating the learning process according to the embodiment 4. In this process, the GPU 13 executes the forward propagation processes with respect to the neuron layers 1-N (S11C). However, the process in S11C is different from the embodiments 1 through 3 in terms of a point that this process is started even when not finishing the learning processes about all the layers at the previous batch. Upon finishing the forward propagation processes about all the layers, the GPU 13 executes the processes in S12 and S13C during a loop of the neuron layer N through the neuron layer 1 (LAYER loop (L) start=N, end=1) in the backward propagation. The process in S12 is the same as in the embodiments 1 through 3.

In the process of S13C, the GPU 13 memory-transfers the variation to the CPU 11 by prioritizing the neuron layer closer to the input side over other neuron layers, and registers the queue in the thread of the executing the aggregation process (S13C). The process in S13C is one example of “transferring coefficient variations to a second processor by prioritizing a coefficient variation of a hierarchy being earlier in an execution sequence of the computation processes in the plurality of hierarchies”.

Accordingly, in the embodiment 4, the GPU 13 executes controlling the priority order whenever finishing the backward propagation process at each neuron layer (L). To be specific, the GPU 13 determines whether the neuron layer with the memory transfer and the aggregation process not yet being executed remains in the queue at the higher-order neuron layer (L+k) than the neuron layer (L) with the backward propagation process being finished. When the higher-order neuron layer (L+k) than the neuron layer (L) with the backward propagation process being finished remains in the queue, the GPU 13 registers the queue by prioritizing the low-order neuron layer (L) closer to the input side. Note that the queue registration, which involves prioritizing the low-order neuron layer, is the same as when the CPU 11 registers the queues for the inter-node communication and the memory transfer (to the GPU 13 from the CPU 11).

The GPU 13 stands by for the completion of the aggregation process of the variation (Δw) of the weight (w) from the CPU 11. According to the embodiment 4, however, the GPU 13 stands by for the completion of the aggregation process per neuron layer (S14C).

Thereafter, the CPU 11 memory-transfers the weight variation (Δw), aggregation-processed by the CPU 11, of each neuron layer (L) to the GPU 13. Upon completing the aggregation process of a certain neuron layer (L), the GPU 13 reflects the aggregation-processed variation (Δw) of the weight (w) of this neuron layer (L) in the weight (w) (S15C). In other words, the GPU 13 updates the weight (w) of the neuron layer (L), which is used for the forward propagation process and the backward propagation process of the next batch.

The GPU 13 determines whether the aggregation processes of all the layers are completed (S16). When the aggregation processes of all the layers are not completed, the GPU 13 determines whether the forward propagation process of the neuron layer (L) of the next batch may be started (S17). When the forward propagation process of the neuron layer (L) of the next batch is disabled from being started, the GPU 13 stands by for the completion of the aggregation process of the next neuron layer by looping back the control to S14C.

Whereas when the forward propagation process of the neuron layer (L) of the next batch can be started, the GPU 13 starts the forward propagation process of the neuron layer (L) of the next batch (S18). The determination in S17 that the forward propagation process can be started implies processing as one example of “updating the coefficient to be used for the computation process from next time onward by prioritizing the coefficient of the hierarchy being earlier in the execution sequence”. The execution of the processes in S16 through S18 is one example of “starting a layer-by-layer process of the hierarchy being earlier in the execution sequence of the next computation process without standing by for a reflection of the integrated coefficient variation about the coefficient to be used at the hierarchy being later in the execution sequence”.

The case that the forward propagation process of the neuron layer (L) of the next batch can be started implies a case that the weight variation (Δw) of the neuron layer 1 of the next batch is aggregation-processed, and the reflection of the aggregation-processed variation (Δw) in the weight (w) is completed. The case concerned further implies, e.g., a case that the forward propagation processes of the neuron layers 1 through L−1 of the next batch are finished; the weight variation (Δw) about the neuron layer (L) is aggregation-processed; and the reflection of the aggregation-processed variation (Δw) in the weight (w) is completed. In such an instance, the GPU 13 starts the forward propagation processes even when not finishing the processes of all the layers of the batch being currently processed. The GPU 13 loops back the processing to S14C.

Whereas when completing the aggregation processes of all the layers, the GPU 13 determines whether the learning is finished (S19). When there remain the unlearned batches prepared for the computing node 10, the GPU 13 executes processing the next batch by looping back the processing to S11C. It may, however, happen that some of the neuron layers of the next batch already start being processed in the forward propagation upon the start of the process in S18 or are already completed in execution of the processing. Accordingly, the process in S11C at the next batch is started even when not finishing the learning processes of all the layers of the previous batch, and is started from the unexecuted neuron layer at the batch concerned.

Note that the GPU 13 executes the reflection process in S15C of FIG. 17, and the CPU 11 may, however, execute the reflection process as in the embodiment 2. The processes in FIG. 17 are executed per neuron layer and may also be executed per segment string by segmenting the parameter string of the weights (w) of the neuron layers into the segment strings as in the embodiment 3.

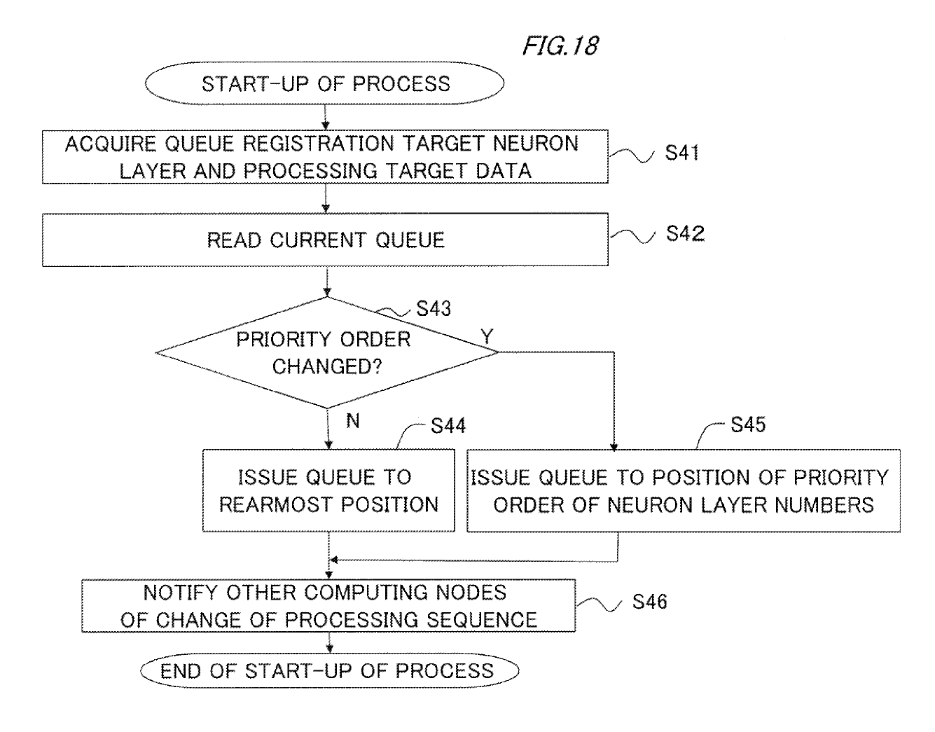

FIG. 18 is a flowchart illustrating a start-up process according to the embodiment 4. This process can be applied to the queue registration when starting up the memory transfer (to the CPU 11 from the GPU 13 after the learning process, the aggregation process, the inter-node communication process and the reflection process of the CPU 11, and the memory transfer (to the GPU 13 from the CPU 11) after the aggregation process. Note that the reflection process itself may be executed by the GPU 13 as in the embodiment 1, and may also be executed by the CPU 11 together with the aggregation process as in the embodiment 2. The processing in FIG. 18 is executed mainly by the GPU 13 or the CPU 11. This processing is the processing of the pre-process (queue issuance thread) described in FIG. 14. Such being the case, the following discussion will describe mainly the queue issuance thread.

The queue issuance thread acquires a queue issuance target neuron layer and processing target data (S41). For example, when the process of the queue issuance thread is completed, it follows that the queue issuance thread acquires the queue issuance target neuron layer and the processing target data.

Next, the queue issuance thread reads the queues that are already registered at the present (S42). The queue issuance thread determines whether a change of the priority order is needed (S43). For example, when each of the neuron layers of the queues already registered at the present is a layer (lower-order layer) closer to the input side than the queue issuance target neuron layer (N in S43), the queue issuance thread registers the queue of the queue issuance target neuron layer in a rearmost position (S44).

Whereas when any of the neuron layers of the queues already registered at the present is a layer (higher-order layer) remoter from the input side than the queue issuance target neuron layer (Y in S43), the queue issuance thread registers the queue of the queue issuance target neuron layer in preference to the higher-order layers (S45). The processes in S43 through S45 are one example of “the first processor transferring the coefficient variations to the second processor by prioritizing the coefficient variation of the hierarchy being earlier in an execution sequence of the computation processes in the plurality of hierarchies”. The processes in S43 through S45 are also one example of “requesting the second processor to execute the transfer/receipt process”. The processes in S43 through S45 are further one example of “the second processor causing the first processor to update the coefficient to be used for the computation process from next time onward by prioritizing the coefficient of the hierarchy being earlier in the execution sequence of the computation process in the plurality of hierarchies”. The queue issuance thread notifies other computing nodes 10 of the change of the processing sequence by the MPI ALLReduce algorithm (S46).

As described above, according to the embodiment 4, the processing sequence is changed to preferentially process the neuron layer closer to the input side. The same is applied to the case in the embodiment 3, in which the weight parameter string (wL) of one neuron layer (L) is segmented into the plurality of segment strings and thus processed. With such a change of the processing sequence, it follows that the learning result of the previous batch is reflected in the weight by prioritizing the neuron layer being closer to the input side and lower in hierarchy in preparation for the batch next to the batch with the processing sequence being changed. In other words, it is feasible to accelerate the update of the weight used for the neuron layer closer to the input data in the next batch.

As in S16 through S18, even when not completing the aggregation processes of all the layers and when the forward propagation process of the lower-order neuron layer can be started in the next batch, the GPU 13 starts the forward propagation processes of the neuron layers (L) of the next batch. Hence, even when the learning result is not reflected in the weights of part of the neuron layers, the learning of the neuron layer closer to the input data can be started at an early stage in the next batch.

### Embodiment 5

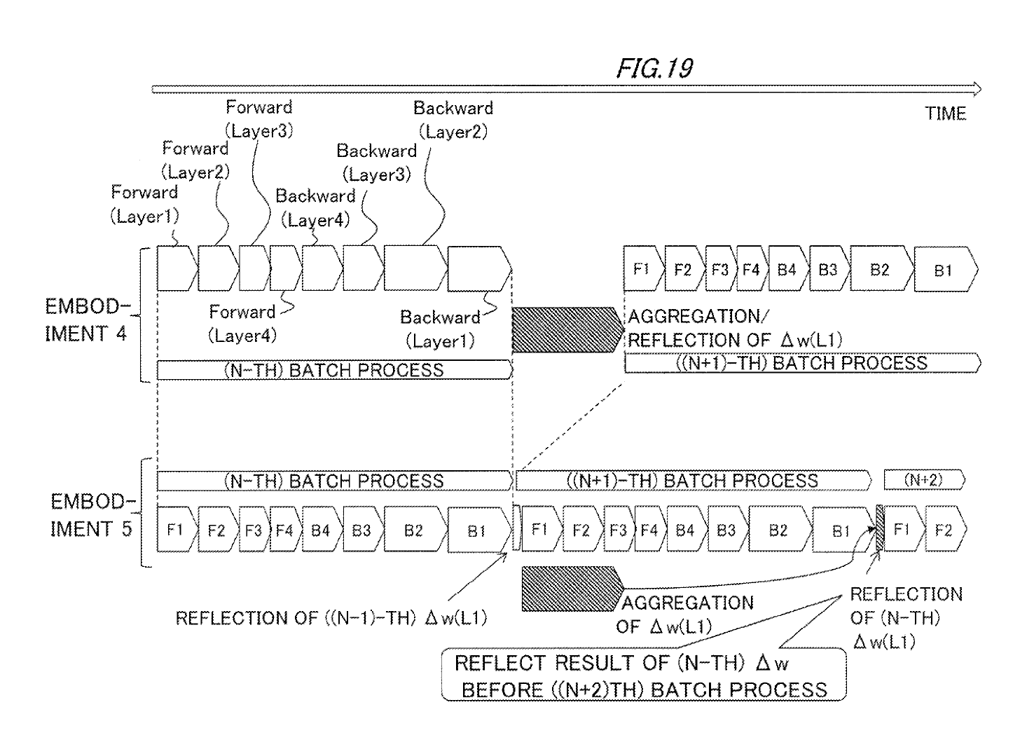

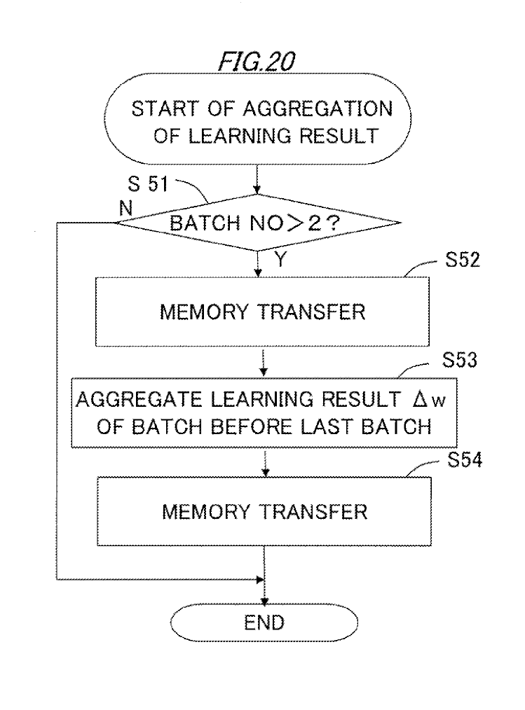

An embodiment 5 will be described with reference to FIGS. 19 and 20. According to the embodiments 1 through 4, after completing the learning process, the aggregation process, the inter-node communication process and the reflection process at one batch, the next batch is started. According to the embodiment 5, upon completing the learning process of a current batch (N-th batch), the learning process of a next batch ((N+1)th batch) is started up before executing the aggregation process, the inter-node communication process and the reflection process. A result of the learning process of the current batch (N-th batch) is reflected in the weight before a further next batch ((N+2)th batch). The procedures other than this procedure according to the embodiment 5 and the components are the same as those in the embodiments 1 through 4. This being the case, the same components of the embodiment 5 as those of the embodiments 1 through 4 are marked with the same numerals and symbols, and the repetitive explanations thereof are omitted.

FIG. 19 illustrates a time chart of the processes according to the embodiment 5 in comparison with the embodiment 4. In FIG. 19, the time chart according to the embodiment 4 is illustrated on a upper side, while the time chart according to the embodiment 5 is depicted on a lower side. The neuron layers 1-4 are assumed in the embodiment 5. The learning processes of the neuron layers 1-4 in the forward propagation are labeled with F1-F4. By contrast, the learning processes of the neuron layers 4-1 in the backward propagation are labeled with B4-B1.

As in FIG. 19, according to the embodiment 5, upon finishing the N-th learning process (the (N-th) batch process), a result (the weight variation (Δw) being already aggregated) of the learning process of the (N−1)th batch is reflected in the weight (w). Then, the learning process (the (N+1)th batch process) for the (N+1)th batch is started. As in FIG. 19, the execution of the learning process of the ((N+1)th) batch process subsequent to the (N-th) batch process is one example of “iteratively executing the computation process and the process of updating the coefficient to be used for the computation process from next time onward a plural number of times”.

Note that as described in the embodiment 2, the processing time can be further reduced by reflecting the result of the learning process of the (N−1)th batch in the weight (w) by the time the (N+1)th learning process is started. As described in the embodiment 3, the processing time can be still further reduced by reflecting the result of the already-aggregated segmented variation (Δw(Lk)) of the learning process of the (N−1)th batch in the segment string (wLk) of the k-th segment weight of the weight (wL) of each layer by the time the learning process of the (N+1)th neuron layer is started. Note that in the embodiment 5 unlike an embodiment 6, the GPU 13 is disabled from starting the ((N+1)th) batch process immediately after the learning process of the (N-th) batch process because of using only one set of buffers to store the weights (w). In other words, the GPU 13 requires the time for reflecting the result (the already-aggregated variation (Δw(Lk)) of the learning process in the weight of each layer before starting the (N+1)th batch process. As in the embodiment 2, when the CPU 11 reflects the result of the learning process in the weight of each layer, the GPU 13 requires the time for retaining the weight in which the CPU 11 has already reflected the result of the learning process in the memory 14 before stating the ((N+1)th) batch process.

It follows in the embodiment 5 that the reflection of the result of the learning process is delayed by one batch as a result of the processes described above in comparison with the embodiment 4. The next batch can be, however, started at the early stage as compared with the embodiment 4 because of not reflecting the result of the learning process in the weight when finishing the learning process. In other words, generally at least the time for aggregating the results of the learning processes is saved in comparison with the embodiment 4.

Note that the processes in FIG. 19 are executed by determining whether there are the unprocessed batches and executing the learning process of the next batch in S16 without executing the processes in S14 and S15 in FIG. 7. An operation that the GPU 13 starts the learning process of the (N+2)th batch upon finishing the (N+1)th learning process in FIG. 19 is one example of “the first processor starting the next computation process before updating the coefficient to be used for the computation process from next time onward, based on a coefficient variation given by the current computation process”.

FIG. 20 illustrates a flowchart in which the CPU 11 executes the aggregation process of aggregating the results of the learning processes according to the embodiment 5. The aggregation process in FIG. 20 is executed in parallel with the (N+1)th learning process after finishing the learning process of, e.g., the N-th batch. In this process, at first, the CPU 11 determines whether the current batch is a batch after the second batch (S51). When the current batch is the first or second batch, the CPU 11 finishes the processing.

Whereas when the batch is the batch after the second batch, the CPU 11 executes the memory transfer, and acquires the result of the learning process of the N-th batch (S52). Then, the CPU 11 aggregates the variations (Δw) of the memory-transferred learning result of the batch (S53). Further, the CPU 11 starts up the memory transfer of the aggregated variation (Δw) to the GPU 13 (S54). Upon receiving the memory transfer in S54, the GPU 13 reflects the aggregated variation (Δw) in the weight (w) before starting the learning process of the (N+2)th batch. The processes in S52 through S54 are one example of a process in which “the coefficient to be used for a further next computation process after the next computation process is updated based on the coefficient variation given by the current computation process”.

Note that the aggregation of the variations (Δw) and the reflection in the weight (w) may be executed by the CPU 11 as in the embodiment 2. In other words, the GPU 13 may receive the weight (w) in which the CPU 11 has already reflected the aggregated variation (Δw) by the memory transfer. In this instance, the reflection process can be simply said to be a process of saving the weight (w) in which the CPU 11 has already reflected the variation (Δw) in the memory 14 of the GPU 13.

As in the embodiment 1, 2, the memory transfer (to the CPU 11 from the GPU 13), the aggregation process of the variations (Δw), the inter-node communication process, the reflection process in the weight (w) and the memory transfer (to the GPU 13 from the CPU 11) may be executed on the per neuron layer basis. These processes may also be executed on the per segment string basis of the parameters segmented more minutely than the per neuron layer basis as in the embodiment 3.

As discussed above, according to the embodiment 5, upon finishing the learning process of the N-th batch, the aggregation process of aggregating the results of the learning processes of the N-th batch is executed in parallel with the learning processes of the (N+1)th batch. Accordingly, as in FIG. 19, the time for the aggregation process is reduced as compared with the embodiments 1 through 4.

The CPU 11 executes the reflection process together with the aggregation process in the same way as in the embodiment 2, in which case the GPU 13 may simply execute the process of saving the weight in which the CPU 11 has already reflected the aggregated variation (Δw) in the memory 14 by the time of starting the learning process of the (N+1)th batch. In this case, the time for the aggregation process and the reflection process is reduced as compared with the embodiments 1 through 4.

### Embodiment 6

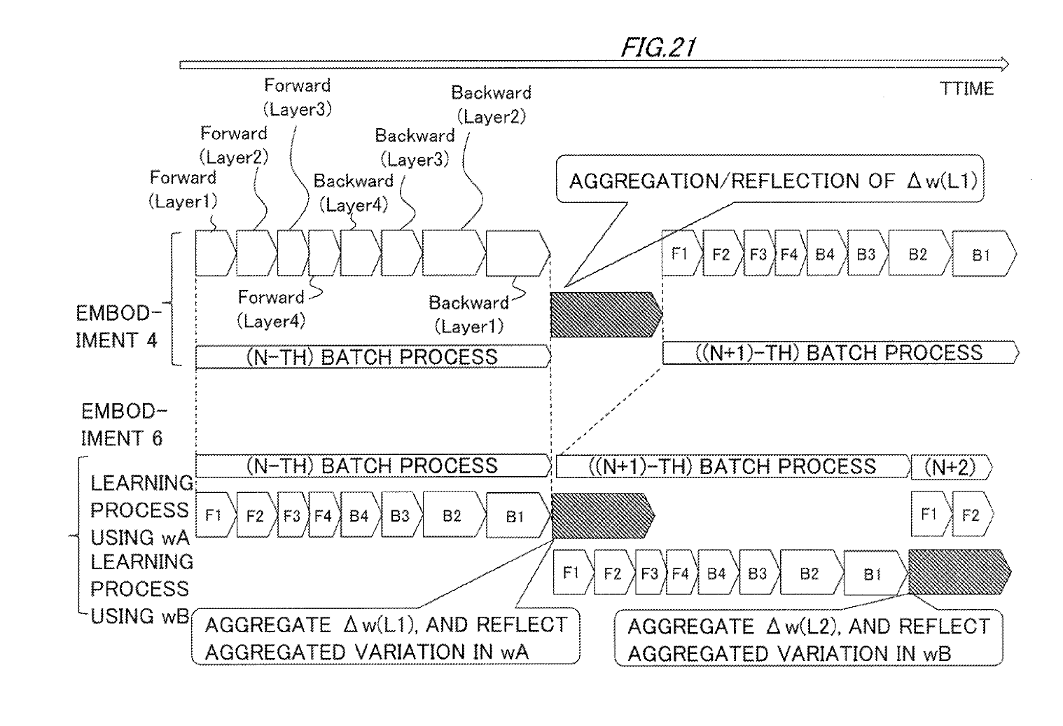

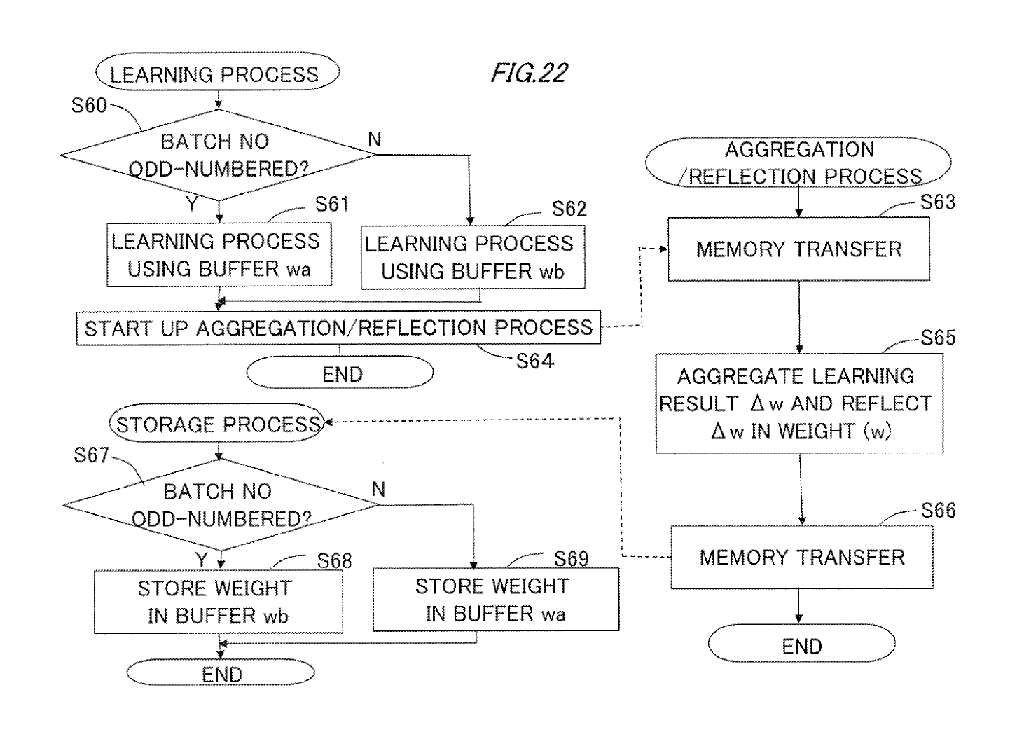

An embodiment 6 will be described with reference to FIGS. 21 and 22. According to the embodiment 5, the computing node 10 aggregates the results of the N-th learning process by the time of the start of learning the (N+2)th batch, and reflects the aggregated result in the weight (w). Such processes enable the computing node 10 to start the (N+1)th learning process immediately after finishing the N-th learning process. In the embodiment 6, the computing node 10 is provided with plural sets of buffers, e.g., two sets of buffers to store the weights (w). To be specific, the computing node 10 has the two sets of buffers to each store the weight (w) in which to already reflect the weight variation (Δw) as the learning result, thereby enabling the learning process of the (N+1)th batch to be started immediately after finishing the N-th batch similarly to the embodiment 5.

FIG. 21 illustrates a time chart according to the embodiment 6 in comparison with the embodiment 4. As in FIG. 21, the embodiment 6 involves alternately executing the learning process using the weights stored in a buffer wa and the learning process using the weights stored in a buffer wb. For example, the aggregation process and the reflection process are executed in parallel with the learning process of a next even-numbered batch after finishing learning an odd-numbered batch. The buffer wa stores the weight (w) in which to already reflect the weight variation (Δw) as a result of the learning process of the odd-numbered batch. Hereat, the weights stored in the buffer wb are used for the learning process of the even-numbered batch.

On the other hand, the aggregation process and the reflection process are executed in parallel with the learning process of a next odd-numbered batch after finishing learning the even-numbered batch. The buffer wb stores the weight (w) in which to already reflect the weight variation (Δw) as a result of the learning process of the even-numbered batch. Hereat, the weights stored in the buffer wa are used for the learning process of the odd-numbered batch.

Accordingly, as in FIG. 21, the learning process of the (N+1)th batch, which uses the weights stored in the buffer wb, is started immediately after finishing the learning process of the N-th batch, which uses the weights stored in the buffer wa. Therefore, as compared with the embodiment 4, the embodiment 6 enables the execution of the aggregation process of the weight variations (Δw) as the result of the learning process after finishing the learning process and the execution of the reflection process in parallel with the learning process of the next batch. Similarly to the embodiment 5, in the embodiment 6 also, the weight in which to already reflect the result of the learning process of the N-th batch is used for learning the (N+2)th batch. The buffers wa, wb in FIG. 21 are one example of “two or more sets of storage units to store the coefficients”.

FIG. 22 illustrates a flowchart of the aggregation process and the reflection process in the embodiment 6. In FIG. 22, the three types of processes, i.e., the learning process, the aggregation/reflection process and a storage process are executed in linkage. The GPU 13 executes the learning process and the storage process, while the CPU 11 executes the aggregation/reflection process. The discussion will herein be made on the assumption that the learning process of the N-th batch is executed.

To begin with, the GPU 13 determines whether the N-th batch is the odd-numbered batch (S60). When the N-th batch is the odd-numbered batch, the GPU 13 executes the learning process using the weights stored in the buffer wa (S61). Whereas when N-th batch is the even-numbered batch, the GPU 13 executes the learning process using the weights stored in the buffer wb (S62). The processes in S61, S62 are one example “executing the computation process by using a first coefficient stored in a first storage unit”. The GPU 13 requests the CPU 11 for the memory transfer and registers a queue for the aggregation/reflection process (S64). The GPU 13 finishes the learning process of the batch concerned. The GPU 13 executes the learning process of the (N+1)th batch.

The CPU 11 accepts the queue for the aggregation process of the weight variation (Δw) as the learning result of the N-th batch and the queue for the reflection process (which will hereinafter be simply termed the aggregation/reflection process), and executes the aggregation/reflection process. The CPU 11 executes the aggregation/reflection process in parallel with the learning process of the (N+1)th batch by the GPU 13.

At first, the CPU 11 acquires the weight variations (Δw) as the learning result of the GPU 13 by the memory transfer (S63). The CPU 11 aggregates the weight variations (Δw), and reflects the aggregated variation in the weight (w) (S65). The process in S65 is the same as S22 through S26 according to the embodiment 2 (FIG. 12). The CPU 11 memory-transfers the weight (w) in which to already reflect the aggregated weight variation (Δw) to the GPU 13 (S66).

The GPU 13, upon receiving the memory transfer, determines whether the current batch is the odd-numbered batch (S67). When the batch is the odd-numbered batch, the GPU 13 stores the weight in the buffer wb (S68). Whereas when the batch is the even-numbered batch, the GPU 13 stores the weight in the buffer wa (S69). The processes in S68, S69 are one example of “storing, in a second storage unit, a second coefficient being updated based on a coefficient variation given by the executed computation process by using the first coefficient”. Note that the processes in S67 through S69 are executed by the time of starting the learning process of the next batch ((N+2)th batch) after the next.

As discussed above, according to the embodiment 6, as in FIG. 21, the learning process of the (N+1)th batch, which uses the weights stored in the buffer wb, can be started immediately after finishing the learning process of the N-th batch, which uses the weights stored in the buffer wa.

<Computer Readable Non-Transitory Recording Medium>

A program making a computer, other machines and apparatuses (which will hereinafter be referred to as the computer and other equivalent apparatuses) attain any one of the functions, can be recorded on a non-transitory recording medium readable by the computer and other equivalent apparatuses. The computer and other equivalent apparatuses are made to read and run the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Among these non-transitory recording mediums, the mediums removable from the computer and other equivalent apparatuses are exemplified by a flexible disc, a magneto-optic disc, a CD-ROM, a CD-R/W, a DVD, a Blu-ray disc, a DAT, an 8 mm tape, and a memory card like a flash memory. A hard disc, a ROM (Read-Only Memory) and other equivalent recording mediums are given as the non-transitory recording mediums fixed within the computer and other equivalent apparatuses. Further, a Solid State Drive (SSD) is also available as the non-transitory recording medium removable from the computer and other equivalent apparatuses and also as the non-transitory recording medium fixed within the computer and other equivalent apparatuses.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such example in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A parallel information processing apparatus comprising:
a plurality of nodes each including a first processor; and
a second processor,
the first processor of each node configured to execute:
a computation process using a coefficient for a processing target data;
computing a coefficient variation based on a result of the computation process;
transferring the computed coefficient variation to the second processor; and
requesting the second processor to execute a transfer/receipt process of transferring the coefficient variation to another node of the parallel information processing apparatus and receiving a coefficient variation computed by another node, and
the second processor of each node configured to execute:
a communication process of transmitting the coefficient variation transferred from the first processor to another node and receiving the coefficient variation computed by another node; and
an aggregation process of integrating the coefficient variation transferred from the first processor and the coefficient variation computed by another node,
at least one of the first processor and the second processor updating the coefficient to be used for the computation process from next time onward, based on the integrated coefficient variation.

2. The parallel information processing apparatus according to claim 1, wherein the computation process includes layer-by-layer processes, to be executed in a predetermined sequence, of a plurality of hierarchies, and each layer-by-layer process of each hierarchy is a process of performing a computation using the coefficient about data input from a hierarchy previous to each hierarchy and outputting a computation result to a next hierarchy,
the first processor computes the coefficient variation at each hierarchy, based on a result of the layer-by-layer process at each hierarchy, and transfers the computed coefficient variation to the second processor, and
the second processor executes two or more aggregation processes about the coefficient variation at each hierarchy in parallel.

3. The parallel information processing apparatus according to claim 2, wherein a plurality of coefficients are used at each of the plurality of hierarchies, and take a form of coefficient string, and
the first processor segments the coefficient string of each of the plurality of hierarchies into a plurality of segment strings, transfers the coefficient variation per segment string to the second processor, and requests the second processor to execute the transfer/receipt process per segment string.

4. The parallel information processing apparatus according to claim 2, wherein the first processor transfers the coefficient variations to the second processor by prioritizing the coefficient variation of the hierarchy being earlier in an execution sequence of the computation processes in the plurality of hierarchies, and requests the second processor to execute the transfer/receipt process.

5. The parallel information processing apparatus according to claim 2, wherein the second processor causes the first processor to update the coefficient to be used for the computation processes from next time onward by prioritizing the coefficient of the hierarchy being earlier in the execution sequence of the computation processes in the plurality of hierarchies.

6. The parallel information processing apparatus according to claim 2, wherein the first processor iteratively executes the layer-by-layer processes of the plurality of hierarchies in the predetermined sequence, and starts the layer-by-layer process of the hierarchy being earlier in the execution sequence of the next computation process without standing by for a reflection of the integrated coefficient variation about the coefficient to be used at the hierarchy being later in the execution sequence when updating the coefficient to be used for the computation processes from next time onward based on the integrated coefficient variation about the coefficient to be used at the hierarchy being earlier in the execution sequence in the plurality of hierarchies.

7. The parallel information processing apparatus according to claim 2, wherein when iteratively executing the computation process and a process of updating the coefficient to be used for the computation processes from next time onward a plural number of times, the first processor starts a next computation process before updating the coefficient to be used for the next computation process based on a coefficient variation given by a current computation process, and the coefficient to be used for a further next computation process after the next computation process is updated based on the coefficient variation given by the current computation process.

8. The parallel information processing apparatus according to claim 1, further comprising two or more storage units to store the coefficient,
the first processor executing the computation process by using a first coefficient stored in a first storage unit, and storing, in a second storage unit, a second coefficient being updated based on a coefficient variation given by the executed computation process by using the first coefficient.

9. An information processing method in a parallel information processing apparatus comprising a plurality of nodes each including a first processor and a second processor, the information processing method comprising:
executing by the first processor of each node, a computation process using a coefficient for a processing target data, computing a coefficient variation based on a result of the computation process, transferring the computed coefficient variation to the second processor, and requesting the second processor to execute a transfer/receipt process of transferring the coefficient variation to another node of the parallel information processing apparatus and receiving a coefficient variation computed by another node from another node;
executing by the second processor of each node, a communication process of transmitting the coefficient variation transferred from the first processor to another node and receiving the coefficient variation computed by another node, and an aggregation process of integrating the coefficient variation transferred from the first processor and the coefficient variation computed by another node; and
updating the coefficient to be used for the computation processes from next time onward, based on the integrated coefficient variation.

10. A computer readable non-transitory recording medium storing a program to be run by a parallel information processing apparatus comprising a plurality of nodes each including a first processor and a second processor, the program comprising:
instructions for causing the first processor of each node to execute a computation process using a coefficient for a processing target data, compute a coefficient variation based on a result of the computation process, transfer the computed coefficient variation to the second processor, and request the second processor to execute a transfer/receipt process of transferring the coefficient variation to another node of the parallel information processing apparatus and receiving a coefficient variation computed by another node from another node;
instructions for causing the second processor of each node to execute a communication process of transmitting the coefficient variation transferred from the first processor to another node and receiving the coefficient variation computed by another node, and an aggregation process of integrating the coefficient variation transferred from the first processor and the coefficient variation computed by another node; and
instructions for causing at least one of the first processor and the second processor to update the coefficient to be used for the computation processes from next time onward, based on the integrated coefficient variation.
